(19) United States
(12) Patent Application Publication
(10) Pub. No.: US 2005/0265920 A1
(43) Pub. Date: Dec. 1, 2005

(54) Supports and catalysts comprising rare earth aluminates, and their use in partial oxidation

(75) Inventors: Cemal Ercan, Tulsa, OK (US); Shuibo Xie, Albany, CA (US); Harold A. Wright, Ponca City, OK (US); Yaming Jin, Ponca City, OK (US); Daxiang Wang, Ponca City, OK (US); Kristi A. Fjare, Ponca City, OK (US); David M. Minahan, Stillwater, OK (US); Beatrice C. Ortego, Ponca City, OK (US); David E. Simon, Bartlesville, OK (US)

Correspondence Address: DAVID W. WESTPHAL;CONOCOPHILLIPS COMPANY - I.P. Legal, P.O. BOX 1267, PONONCA CITY, OK, 74602-1267, US

(73) Assignee: ConocoPhillips Company, Houston, TX (US)

(21) Appl. No.: 11/139,233

(22) Filed: May 27, 2005

Related U.S. Application Data
(63) Continuation-in-part of application No. 10/706,645, filed on Nov. 12, 2003.
(60) Provisional application No. 60/425,381, filed on Nov. 11, 2002.
(60) Provisional application No. 60/425,383, filed on Nov. 11, 2002.
(60) Provisional application No. 60/501,185, filed on Sep. 8, 2003.

(51) Int. Cl. C01B 3/26

(52) U.S. Cl. 423/651; 502/302

(57) ABSTRACT

The present invention relates to thermally stable supports and catalysts for use in high temperature operation, and methods of preparing such supports and catalysts, which includes adding a rare earth metal to an aluminum-containing precursor prior to calcining. The present invention can be more specifically seen as a support, process and catalyst wherein the thermally stable support comprises two rare earth aluminates of different molar ratios of aluminum to rare earth metal, and optionally, alumina and/or a rare earth oxide. More particularly, the invention relates to the use of noble metal catalysts comprising the thermally stable support for synthesis gas production via partial oxidation of light hydrocarbon (e.g., methane) with minimal deactivation over long-term operations and further relates to gas-to-liquids conversion processes.

### CROSS-REFERENCE TO RELATED APPLICATIONS

The present application is a continuation-in-part application of a non-provisional application Ser. No. 10/706,645 filed Nov. 12, 2003, entitled “Stabilized Alumina Supports, Catalysts made therefrom, and Their Use in Partial Oxidation,” which claims the benefit to U.S. Provisional Application Ser. No. 60/425,381 filed Nov. 11, 2002, entitled “Novel Syngas Catalysts and Their Method of Use,” U.S. Provisional Application Ser. No. 60/425,383 filed Nov. 11, 2002, entitled “Improved Supports for High Surface Area Catalysts” and U.S. Provisional Application Ser. No. 60/501,185 filed Sep. 8, 2003, entitled “Stabilized Alumina Supports, Catalysts Made Therefrom, And Their Use in Partial Oxidation,” and which are hereby incorporated by reference in their entirety herein for all purposes.

### STATEMENT REGARDING FEDERALLY SPONSORED RESEARCH OR DEVELOPMENT

Not applicable.

### TECHNICAL FIELD OF THE INVENTION

The present invention generally relates to catalyst supports having high thermal stability in ultra high temperature conditions, and supported catalysts made therefrom having very low deactivation rate when subjected to high temperature and high pressure catalytic conversion. The present invention particularly relates to processes for making synthesis gas via the catalytic partial oxidation of light hydrocarbons (e.g., methane or natural gas).

### BACKGROUND OF THE INVENTION

It is well known that the efficiency of supported catalyst systems is often related to the surface area on the support. This is especially true for systems using precious metal catalysts or other expensive catalysts. The greater the surface area, the more catalytic material is exposed to the reactants and the less time and catalytic material is needed to maintain a high rate of productivity.

Alumina (Al₂O₃) is a well-known support for many catalyst systems. It is also well known that alumina has a number of crystalline phases such as alpha-alumina (often noted as α-alumina or α-Al₂O₃), gamma-alumina (often noted as γ-alumina or γ-Al₂O₃) as well as a myriad of alumina polymorphs. One of the properties of gamma-alumina is that it has a very high surface area. This is commonly believed to be because the aluminum and oxygen molecules are in a crystalline structure or form that is not very densely packed. Gamma-Al₂O₃ is a particularly important inorganic oxide refractory of widespread technological importance in the field of catalysis, often serving as a catalyst support. Gamma-Al₂O₃ is an exceptionally good choice for catalytic applications because of a defect spinel crystal lattice that imparts to it a structure that is both open and capable of high surface area. Moreover, the defect spinel structure has vacant cation sites giving the gamma-alumina some unique properties. Gamma-alumina constitutes a part of the series known as the activated, transition aluminas, so-called because it is one of a series of aluminas that can undergo transition to different polymorphs. Santos et al. (Materials Research, 2000, vol. 3 (4), pp. 104-114) disclosed the different standard transition aluminas using Electron Microscopy studies, whereas Zhou et al. (Acta Cryst., 1991, vol. B47, pp. 617-630) and Cai et al. (Phys. Rev. Lett., 2002, vol. 89, pp. 235501) described the mechanism of the transformation of gamma-alumina to theta-alumina.

The oxides of aluminum and the corresponding hydrates, can be classified according to the arrangement of the crystal lattice with γ-Al₂O₃ being part of the γ series by virtue of a cubic close packed (ccp) arrangement of oxygen groups. Some transitions within a series are known, for example, low-temperature dehydration of an alumina trihydrate (gibbsite, γ-Al(OH)₃) at 100° C. provides an alumina monohydrate (boehmite, γ-AlO(OH)). Continued dehydration at temperatures below 450° C. in the γ series leads to the transformation from boehmite to the completely dehydrated γ-Al₂O₃. Further heating may result in a slow and continuous loss of surface area and a slow conversion to other polymorphs of alumina having much lower surface areas. Higher temperature treatment ultimately provides α-Al₂O₃, a denser, harder oxide of aluminum often used in abrasives and refractories. Unfortunately, when gamma-alumina is heated to high temperatures, the structure of the atoms collapses such that the surface area decreases substantially. The most dense crystalline form of alumina is alpha-alumina. Thus, alpha-alumina has the lowest surface area, but is the most stable at high temperatures. The structure of alpha-alumina is less well suited to certain catalytic applications, such as in the Fischer-Tropsch process because of a closed crystal lattice, which imparts a relatively low surface area to the catalyst particles.

Alumina is ubiquitous as supports and/or catalysts for many heterogeneous catalytic processes. Some of these catalytic processes occur under conditions of high temperature, high pressure and/or high water vapor pressure. The prolonged exposure to high temperature typically exceeding 1,000° C., combined with a significant amount of oxygen and sometimes steam can result in catalyst deactivation by support sintering. The sintering of alumina has been widely reported in the literature (see for example Thevenin et al, Applied Catalysis A: General, 2001, vol. 212, pp. 189-197), and the phase transformation due to an increase in operating temperature is usually accompanied by a sharp decrease in surface area. In order to prevent this deactivation phenomenon, various attempts have been made to stabilize the alumina support against thermal deactivation (see Beguin et al., Journal of Catalysts, 1991, vol. 127, pp. 595-604; Chen et al., Applied Catalysis A: General, 2001, vol. 205, pp. 159-172).

The research focusing on the thermal stabilization of alumina led to the development of high temperature-resistant materials such as hexaaluminates (Matsuda et al., 8^{th} International Congress on Catalysis Proceedings, Berlin, 1984, vol. 4, pp. 879-889; Machida et al., Chemistry Letters, 1987, vol. 5, pp. 767-770) and the investigation of other potential oxide materials such as perovskites, spinels, and garnets, which have been examined with respect to both the thermal stability and catalytic performance.

Hexaaluminate structures have been shown to be effective structures for combustion catalysts because they provide excellent thermal stability and a higher surface area than alpha-alumina. Of particular interest, Arai and coworkers in Japan have developed hexaaluminates and substituted hexaluminates as combustion catalysts (Arai & Machida, Catalysis Today, 1991, vol. 10, pp. 81-95), and showed that the most promising stabilizer for combustion catalysts was barium (Arai & Machida, Applied Catalysis A: General, 1996, vol. 138, pp. 161-176). The investigation of the hexaaluminate material for the use of combustion has been described for example in Machida et al. (Journal of Catalysis, 1990, vol. 123, pp. 477-485) and in Groppi et al. (Applied Catalysis A: general, 1993, vol. 104, pp. 101-108). Machida et al. (Journal of American Ceramic Society, 1988, vol. 71, pp. 1142-1147) discovered that the crystal growth of one type of hexaaluminates, beta-alumina, also known as magnetoplumbite, was quite slow and anisotropic, and they proposed that its anisotropic growth may be the reason why the hexaaluminate can retain a large surface area at elevated temperatures. Arai and Machida (Catalysis Today, 1991, vol. 10, pp. 81-95) also disclosed that the thermal resistance of hexaaluminates seems to be quite dependent on the preparation procedures, primarily due to the difference of formation mechanism of hexaaluminates in various procedures. Kato et al. (Journal of American Ceramic Society, 1987, vol. 71(7), pp. C157-C159) disclosed a co-precipitation method to prepare mixtures of lanthanum and aluminum precursors, which resulted in formation of lanthanum beta-alumina structures with high surface area.

Destabilization of the support is not the sole cause of catalyst deactivation at high temperature. Stabilizing the catalytically active species on a thermally stable support is also needed. When an active species is supported on an oxide support, solid state reactions between the active species and the oxide support can take place at high temperature, creating some instability. That is why Machida et al. (Journal of Catalysis, 1989, vol. 120, pp. 377-386) proposed the introduction of cations of active species through direct substitution in the lattice site of hexaaluminates in order to suppress the deterioration originating from the solid state reaction between the active species and the oxide support. These cation-substituted hexaaluminates showed excellent surface area retention and high catalytic activity (see the hexaaluminate examples with Sr, La, Mn combinations in Machida et al., Journal of Catalysis, 1990, vol. 123, pp. 477-485). Therefore, the preparation procedure for high temperature catalysts is critical for thermal stability and acceptable surface area.

It has long been a desire in the catalyst support arts to have a form of alumina that has high surface area like gamma-alumina and stability at high temperature like alpha-alumina. Such a catalyst support would have many uses.

One such use is in the production of synthesis gas in a catalytic partial oxidation reactor. Synthesis gas is primarily a mixture of hydrogen and carbon monoxide and can be made from the partial burning of light hydrocarbons with oxygen. The hydrocarbons, such as methane or ethane are mixed with oxygen or oxygen containing gas and heated. When the mixture comes in contact with an active catalyst material at a temperature above an initiation temperature, the reactants quickly react generating synthesis gas and a lot of heat. This very fast reaction requires only milliseconds of contact of the reactant gases with the catalyst. The combination of high exothermicity and very fast reaction time causes reactor temperatures to exceed 800° C., often going above 1,000° C. and even sometimes going above 1,200° C. Since catalysts used in the partial oxidation of hydrocarbons are typically supported, the support should be able to sustain this high thermal condition during long-term operation. In other words, a stable catalyst support which retains most of its surface area while enduring very high temperature, is desirable for long catalyst life.

The reaction pathway for partial oxidation of methane to synthesis gas is still being debated. Two alternate pathways have been proposed (Dissanayake et al., J. Catal., 1991, vol. 132, pp. 117; Jin et al., Appl. Catal., 2000, vol. 201, pp. 71; Heitne et al., Catal. Today, 1995, vol. 24, pp. 211). 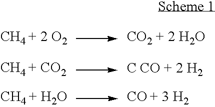 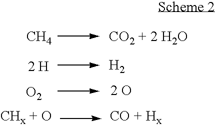
These two pathways have come to be known as the combustion-reforming mechanism (Scheme 1) and the direct partial oxidation mechanism (Scheme 2). In Scheme 1, methane is completely oxidized to CO₂ and water, and CO is a result of the reforming of water and CO₂ with the residual methane. In Scheme 2, methane is pyrolyzed over the catalyst to produce CO directly without the pre-formation of CO₂.

Weng, et al. (The Chemical Record, 2002, vol. 2, pp. 102-113) reported in situ Fourier transform infrared (FTIR) studies of the catalytic partial oxidation (CPOX) mechanism of methane over rhodium and ruthenium based catalysts supported on silica and alumina. They specifically studied the influence of the catalyst pretreatment conditions and their relationship with the concentration of oxygen species on the surface of the catalysts under reaction conditions. They concluded that a) the CPOX mechanism, whether based on Scheme 2 (i.e., -direct oxidation) or based on Scheme 1 (combustion/reforming), is determined by the amount of O²⁻ on the catalyst surface; b) an oxidized catalyst, such as Rh₂O₃, promotes the combustion/reforming mechanism (Scheme 1), whereas rhodium in the reduced state will promote the direct pathway (Scheme 2); c) rhodium on gamma-alumina under normal feed conditions of methane to molecular oxygen ratio in the feed will contain mostly oxidized Rh, even if rhodium was pre-reduced; d) the reducibility of rhodium is greatly affected by the support; and e) a lower reduction peak temperature, as measured by temperature-programmed reduction (TPR), indicates a weaker Rh—O bond.

A weaker Rh—O bond would lead to easier removal of the surface oxygen, and therefore the lower TPR temperature peak. During normal operating conditions, a weaker Rh—O bond should promote reduced rhodium on the surface, which would favor a direct pathway. In turn, this would lead to lower catalyst surface temperatures, which should slow the alumina phase transformation to ultimately alpha-Al₂O₃ (also slowing deactivation).

Roh et al. (Chemistry Letters, 2001, vol. 7, pp. 666-667) reported that nickel based partial oxidation catalyst based on theta-alumina had high activity as well as high stability, and they ascribed the excellent performance of these catalyst to the combination of the strong interactions between nickel and theta-alumina and the coexistence of reduced and oxidized nickel species. Liu et al. (Korean J. Chem. Eng., 2002, vol. 19, pp. 742-748) have also shown that a protective layer between Ce—ZrO2 and theta-alumina is formed to suppress the formation of nickel-aluminate spinel structures, which would result in catalyst deactivation. Moreover Miao et al. (Appl. Catal. A, 1997, vol. 154, pp. 17-27) indicated that the modification with an alkali metal (Li, Na, K) oxide and a rare earth metal (La, Ce, Y, Sm) oxide improved the ability of a nickel catalyst on alumina to suppress carbon deposition over the catalyst during partial oxidation of methane. Therefore, the type of support used and the catalytic metal-support interactions are major factors in the catalyst stability and can have an effect on the reaction mechanism.

In addition to the selection and careful preparation of the support, catalyst composition also plays an important role in catalyst activity in catalytic partial oxidation of light hydrocarbons and selectivity towards to the desired products. Noble metals typically serve as the best catalysts for the partial oxidation of methane. Noble metals are however scarce and expensive, making their use economically challenging especially when the stability of the catalyst is questionable. One of the better known noble metal catalysts for catalytic partial oxidation comprises rhodium. Rhodium-based syngas catalysts deactivate very fast due to sintering of both catalyst support and/or metal particles. Prevention of any of these undesirable phenomena is well-sought after in the art of catalytic partial oxidation processes, particularly for successful and economical operation at commercial scale.

It would therefore be highly desirable to create a thermally-stable high surface area support with a metal from Groups 8, 9, or 10 of the Periodic Table of the Elements (based on the new WUPAC notation, which is used throughout the present specification), particularly with rhodium, loaded onto said support for highly productive long lifetime catalysts for the syngas production, specifically via partial oxidation.

### SUMMARY OF THE INVENTION

The current invention addresses the stability and durability of catalyst supports and catalysts made therefrom for use in reactors operating at very high temperatures. Particularly, the present invention relates to a high surface area aluminum-based support comprising a transition alumina phase and at least one stabilizing agent. The transition alumina phase preferably comprises theta-alumina and may contain any other alumina phases comprised between low-temperature gamma-alumina and high-temperature stable alpha-alumina. The transition alumina phase preferably comprises mainly a theta-alumina phase. The alumina support preferably may further comprise alpha-alumina, but is preferably substantially free of gamma-alumina. The stabilizing agent comprises at least one element from Groups 1-14 of the Periodic Table of Elements, and is preferably selected from the group consisting of rare earth metals, alkali earth metals and transition metals. The inventive support also is thermally stable at temperatures above 800° C.

The present invention also relates to a thermally stable aluminum-based material, which is suitable as a catalyst support for high temperature reactions. The thermally stable aluminum-based material includes a rare earth aluminate comprising at least one rare earth metal, wherein the rare earth aluminate has a molar ratio of aluminum to rare earth metal (Al:Ln) greater than 5:1. The rare earth aluminate with an Al:Ln greater than 5:1 preferably comprises a lanthanide metal selected form the group consisting of lanthanum, praseodymium, cerium, neodymium, samarium, and combinations thereof. In preferred embodiments, the rare earth aluminate comprises a hexaaluminate-like structure or a beta-alumina-like structure, which comprises an Al:Ln between 11:1 and 14:1.

The present invention further relates to a thermally stable aluminum-based catalyst support, wherein the thermally stable aluminum-based catalyst support comprises an aluminum oxide phase selected from the group consisting of alpha-alumina, theta-alumina, or combinations thereof; and a rare earth aluminate comprising a rare earth metal, wherein the alumina-like rare earth aluminate has a molar ratio of aluminum to rare earth metal greater than 5:1. The rare earth aluminate with a high molar ratio of aluminum to rare earth metal comprises from 100 wt % of the support and more preferably less than 100 wt % down to as little as 1 wt % of the material weight in the catalyst support. In preferred embodiments, the thermally stable support comprises between about 1 wt % and about 50 wt % of said rare earth aluminate. In other embodiments, the thermally stable aluminum-based catalyst support could comprise between 40 wt % and 100 wt % of rare earth aluminate; and in some cases, the support is a rare earth aluminate or a mixture of rare earth aluminates with a molar ratio of aluminum to rare earth metal greater than 5:1. The thermally stable catalyst support could contain between about 1 wt % and about 20 wt % of rare earth metal; preferably between about 1 wt % and about 10 wt % of rare earth metal. The rare earth aluminate preferably comprises lanthanum, praseodymium, cerium, neodymium, samarium, or combinations thereof. In preferred embodiments, the rare earth aluminate comprises a hexaaluminate-like structure, a beta-alumina like structure, or combinations thereof In these preferred embodiments, the thermally stable catalyst support comprises at least one rare earth aluminate with an aluminum-to-rare earth molar ratio between 11:1 and 14:1; and at least one aluminum oxide phase selected from alpha-alumina, theta-alumina, or combinations thereof. The thermally stable aluminum-based material may further comprise a transition alumina, such as delta-alumina, eta-alumina, kappa-alumina, chi-alumina, rho-alumina, kappa-alumina, or any combinations thereof, but is preferably substantially free of gamma-alumina.

The method for making a high surface area aluminum-based support includes applying at least one stabilizing agent to an aluminum-containing precursor following by heat treatment, wherein the heat treatment conditions are selected such that a portion of the aluminum-containing precursor is transformed to a transition alumina and optionally to alpha-alumina, wherein the transition alumina comprises delta-alumina, eta-alumina, kappa-alumina, chi-alumina, rho-alumina kappa-alumina, or any combinations thereof The heat treatment can also be effective in transforming another portion of the aluminum-containing precursor to an aluminate comprising at least a portion of said stabilizing agent, and wherein the resulting support is preferably substantially free of gamma-alumina. The stabilizing agent preferably comprises a rare earth metal. The stabilizing agent preferably includes a lanthanide metal selected from the group consisting of lanthanum, cerium, neodymium, praseodymium, and samarium, but may further include any element from Groups 1-14 of the Periodic Table (new IUPAC notation) such as an alkali metal, an alkali earth metal, a second rare earth metal, or a transition metal. The aluminum-containing precursor comprises at least one material selected from the group consisting of an oxide of aluminum, a salt of aluminum, an alkoxide of aluminum, a hydroxide of aluminum, and combinations thereof.

The present invention also includes a method for making a thermally stable aluminum-based catalyst support suitable for use in a high temperature reaction. This method includes applying at least one rare earth metal compound to an aluminum-containing precursor; and treating by heat the applied precursor, wherein the heat treatment conditions are selected such that at least a portion of the aluminum-containing precursor is transformed to an aluminate comprising at least a portion of said rare earth metal, and wherein the rare earth aluminate comprises an aluminum-to-rare earth metal molar ratio greater than 5:1. The heat treatment is performed in a manner effective to obtain about 1 wt % and 100 wt % of said rare earth aluminate in the thermally stable catalyst support; preferably more than 1 wt % but less than 100 wt % of said rare earth aluminate. In some embodiments, the heat treatment is performed in a manner effective to obtain between about 1 wt % and about 50 wt % of said rare earth aluminate in the thermally stable support. In other embodiments, the heat treatment is performed in a manner effective to obtain between 40 wt % and 100 wt % of rare earth aluminate in the thermally stable catalyst support. In preferred embodiments, the heat treatment is performed in a manner effective to obtain between 50 wt % and 95 wt %, preferably between 60 wt % and 90 wt %, of rare earth aluminate in the thermally stable catalyst support. In some alternate embodiments, the heat treatment is performed in a manner effective to transform all of the aluminum-containing precursor to at least one rare earth aluminate with an aluminum-to-rare earth metal molar ratio greater than 5:1. In other embodiments, the heat treatment is performed in a manner effective to transform all of the aluminum-containing precursor to one rare earth-lean aluminate with an aluminum-to-rare earth metal molar ratio greater than 5:1 and one rare earth-rich aluminate with an aluminum-to-rare earth metal molar ratio less than 5:1. The rare earth-lean and -rich aluminates preferably contain at least one common rare earth. The application and heating steps preferably employ an impregnation technique and calcination in an oxidizing atmosphere, respectively. Additionally, the heat treatment step is effective to transform another portion of said aluminum-containing precursor to an aluminum oxide phase comprising alpha-alumina, a transition alumina, or combinations thereof, wherein the transition alumina comprises delta-alumina, eta-alumina, kappa-alumina, chi-alumina, rho-alumina, kappa-alumina, theta-alumina, or any combinations thereof. The transition alumina comprises preferably theta-alumina. Additionally or alternatively, the heat treatment step is effective to transform a portion of rare earth-containing precursor to a rare earth oxide phase.

The invention further includes a catalyst comprising a catalytically active metal selected from the group consisting of rhodium (Rh), ruthenium (Ru), iridium (kr), platinum (Pt), palladium (Pd), and rhenium (Re), on a thermally stabilized support wherein the thermally stabilized support comprises theta-alumina, a rare earth aluminate with an aluminum to rare earth metal molar ratio greater than 5:1, or combinations thereof.

More particularly, the invention includes a catalyst comprising a catalytically active metal selected from the group consisting of rhodium (Rh), ruthenium (Ru), iridium (fr), platinum (Pt), palladium (Pd), and rhenium (Re), on a thermally stabilized support wherein the thermally stabilized support comprises between about 1 wt % and 100 wt % of a rare earth aluminate with an aluminum to rare earth metal molar ratio greater than 5:1; preferably more than 1 wt % but less than 100 wt % of said rare earth aluminate with an aluminum to rare earth metal molar ratio greater than 5:1; preferably more than 50 wt % but less than 95 wt % of said rare earth aluminate with an aluminum to rare earth metal molar ratio greater than 5:1.

A more specific embodiment of the invention relates to a partial oxidation catalyst with an active ingredient selected from the group consisting of rhodium, iridium, and ruthenium; and an optional promoter loaded onto a thermally stable support, wherein said support includes an alumina phase selected from the group consisting of alpha-alumina, theta-alumina, or any combinations thereof; and between about 1 wt % and about 50 wt % of a rare earth aluminate with a molar ratio of aluminum to said rare earth metal greater than 5:1. In other embodiments, the thermally stable aluminum-based catalyst support could comprise more than 40 wt % of rare earth aluminate and less than 100 wt % of rare earth aluminate.

The present invention can be more specifically seen as a support, process and catalyst for a partial oxidation reaction, wherein the support comprises a rare earth aluminate having a molar ratio of aluminum to rare earth metal greater than 5:1, and wherein the rare earth aluminate preferably comprises an element selected from the group consisting of lanthanum, cerium, praseodymium, samarium, and neodymium. The support may comprise between 1 wt % and 100 wt % of the rare earth aluminate. In preferred embodiments, the thermally stable support comprises between about 1 wt % and about 50 wt % of said rare earth aluminate. In other embodiments, the thermally stable aluminum-based catalyst support could comprise between 40 wt % and 100 wt % of the rare earth aluminate; and in some alternate embodiments, the support is a rare earth aluminate or a mixture of rare earth aluminates with an aluminum to rare earth metal molar ratio greater than 5:1. The supported catalyst comprises at least one catalytically active metal selected from the group consisting of rhodium, ruthenium, iridium, platinum, palladium, and rhenium, preferably selected from the group consisting of rhodium, iridium, and ruthenium, and optionally the catalyst can also comprise a promoter.

More particularly, the invention relates to processes for the catalytic partial oxidation of light hydrocarbons (e.g., methane or natural gas) to produce primarily synthesis gas and the use of such supported catalysts to make carbon monoxide and hydrogen under conditions of high gas hourly space velocity, elevated pressure and high temperature.

The process for making synthesis gas comprises converting a gaseous hydrocarbon stream and an oxygen-containing stream over a partial oxidation catalyst, to make a product stream comprising CO and H₂, wherein said partial oxidation catalyst includes an active ingredient comprising rhodium, iridium, platinum, palladium, ruthenium, or combinations thereof, and a support comprising a rare earth aluminate, said rare earth aluminate having a molar ratio of aluminum to rare earth metal greater than 5:1. The support could comprise between about 1 wt % and 100 wt % of said rare earth aluminate, preferably between about 1 wt % and about 50 wt % of said rare earth aluminate. In other embodiments, the support could comprise between 40 wt % and 100 wt % of the rare earth aluminate; and in some alternate embodiments, the support is a rare earth aluminate or a mixture of rare earth aluminates with an molar ratio of aluminum to rare earth metal greater than 5:1. The rare earth metal is selected from the group consisting of lanthanum, neodymium, praseodymium, cerium, and combinations thereof, and the support could comprise between about 1 wt % and about 20 wt % of the rare earth metal, but preferably between about 1 wt % and about 10 wt % of the rare earth metal. The support may further comprise an aluminum oxide such as alpha-alumina, a transition alumina, or combinations thereof, wherein the transition alumina comprises delta-alumina, eta-alumina, kappa-alumina, chi-alumina, rho-alumina, kappa-alumina, theta-alumina, or any combinations thereof. The transition alumina comprises preferably theta-alumina. The support may further comprise an oxide of said rare earth metal and/or an aluminate of said rare earth aluminate with a low aluminum to rare earth metal molar ratio, such as below 2:1.

The present invention further relates to catalysts and processes for the conversion of gaseous light hydrocarbons for producing a hydrocarbon product, comprising primarily hydrocarbons with 5 carbons atoms or more (C₅₊).

In one embodiment, needs in the art are addressed by a high temperature stable syngas catalyst. The catalyst comprises an active ingredient comprising a metal selected from the group consisting of rhodium, iridium, platinum, palladium, ruthenium, oxides thereof, and combinations thereof. The active ingredient is supported on a catalyst support comprising a rare earth-rich aluminate with a molar ratio of aluminum to rare earth metal less than 5:1; and a rare earth-lean aluminate with a molar ratio of aluminum to rare earth metal greater than 5:1. The support is in the form of discrete structures.

In another embodiment, needs in the art are addressed by a method for making synthesis gas. The method comprises converting a gaseous hydrocarbon stream and an oxygen-containing stream over a partial oxidation catalyst, to make a product stream comprising CO and H₂. The partial oxidation catalyst includes an active ingredient comprising a metal selected from the group consisting of rhodium, iridium, platinum, palladium, ruthenium, and combinations thereof. The method further comprises a support in the form of discrete structures, said support comprising a rare earth-lean aluminate having a molar ratio of aluminum to rare-earth metal greater than 5:1, and a rare earth-rich aluminate having a molar ratio of aluminum to rare-earth metal greater than 5:1.

Another embodiment addresses needs in the art by a method for making a thermally stable supported syngas catalyst suitable for long-term operation in a partial oxidation reactor at high pressure and temperature. The method comprises impregnating a solution of a rare earth metal-containing compound onto an aluminum-containing precursor in the form of discrete structures. The method further comprises drying the impregnated aluminum-containing precursor. In addition, the method comprises calcining at a temperature of about 1,100° C. or higher in a manner effective so as to react the aluminum-containing precursor with at least a fraction of said rare earth metal to form a support comprising a rare earth-rich aluminate, a rare earth-lean aluminate, and less than 25 wt % of alumina, wherein the rare earth-rich aluminate has a molar ratio of aluminum to rare earth metal less than 5:1, and the rare earth-lean aluminate has a molar ratio of aluminum to rare earth metal greater than 5:1. Moreover, the method comprises depositing an active ingredient compound onto said support, wherein the active ingredient comprises a metal selected from the group consisting of rhodium, iridium, platinum, palladium, ruthenium, oxides thereof, and combinations thereof, calcining and reducing the deposited support so as to form an activated catalyst, and heat treating the activated catalyst in an inert atmosphere at a temperature of at least about 1,100° C. to obtain the thermally stable supported syngas catalyst.

### BRIEF DESCRIPTION OF THE DRAWINGS

For a more detailed understanding of the preferred embodiments, reference is made to the accompanying drawings, wherein:

FIG. 1 represents the temperature programmed reduction (TPR) profile of a catalyst comprising mainly theta-alumina according to this invention;

FIGS. 2a, 2b and 2c represent the XRD analysis of materials comprising various loadings of lanthanum applied to gamma-alumina and calcined at different temperatures;

FIGS. 3a and 3b represent the effect of lanthanum loadings on the resulting surface area and pore volume (respectively) of catalyst supports made at two different calcinations temperatures;

FIG. 4 represents the performance data for synthesis gas production from a catalyst made according to a preferred embodiment of the invention;

FIGS. 5a-5d illustrate the improved performance (hydrocarbon conversion, the hydrogen selectivity, CO selectivity, and exit temperature) of a partial oxidation process employing 4% Rh catalysts according to the present invention compared to catalysts supported on alpha-alumina at a pressure of 90 psig (about 722 kPa);

FIGS. 6a-6d illustrate the improved performance (hydrocarbon conversion, the hydrogen selectivity, CO selectivity, and exit temperature) of a partial oxidation process employing 2% Rh catalysts according to the present invention compared to catalysts supported on alpha-alumina at a pressure of 90 psig (about 722 kPa); and

FIG. 7 illustrates the improved performance (hydrocarbon conversion, the hydrogen seletivity, CO selectivity) of a large-scale partial oxidation process employing 4% Rh catalysts according to the present invention at a pressure of 180 psig (about 1340 kPa).

### DETAILED DESCRIPTION OF PREFERRED EMBODIMENTS

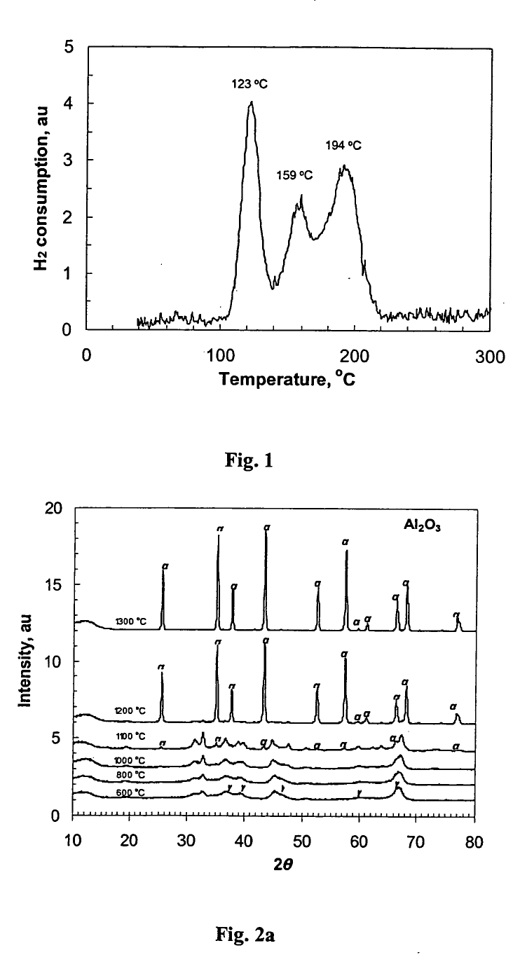

The present invention is based on the surprising discovery that a supported rhodium-based catalyst supported on an aluminum-based matrix modified with a lanthanum compound showed excellent performance with conversion and selectivities above 90%, and a sustainable activity over more than 300 hours on line while in contact with natural gas and molecular oxygen under suitable conditions for catalytic partial oxidation, namely at high temperatures and at high pressure. It was found that this catalyst initially comprised about 65% theta-alumina phase, some small amount of alpha-alumina (10%), but was free of gamma-alumina. In addition, the catalyst comprised a good portion of lanthanum aluminum mixed oxide compounds (La—Al—O) with a hexaaluminate-like structure (18%). This hexaaluminate-like structure comprised the majority of the lanthanum. Moreover, this catalyst showed a low reduction peak temperature in a TPR analysis (shown in FIG. 1), much lower than similar catalysts which comprised supports with less theta-alumina phase, more gamma-alumina, minimal amount of rare earth aluminates, and substantially almost no alpha-alumina, or for similar catalysts which comprised supports of mainly alpha-alumina.

As described in Weng et al. (The Chemical Record, 2002, vol. 2, pp. 101-113), it is believed that a low TPR peak temperature is an indication of a loose Rh—O bond, thereby favoring the formation of reduced rhodium on the surface of the catalyst, which in turn favors the direct mechanism of partial oxidation (Scheme 2). The direct mechanism generates a lot less heat (the heat of CH₄+½O₂ reaction is −6.6 kcal/mol) whereas the combustion reaction in Scheme 1 generates much more heat (as the heat of CH₄+2O₂ is −191.3 kcal/mol). Therefore, the direct mechanism should produce a cooler catalyst surface temperature. Without wishing to be bound to this theory, the Applicant believes that the presence of a theta-alumina phase might increase oxygen mobility, increases the fraction of rhodium in reduced state, increases the conversion of methane (and other light hydrocarbons) via the direct mechanism and thereby reduces the catalyst surface temperature. It is expected that a cooler catalyst surface temperature prevents or minimizes the formation of carbonaceous deposit on the catalyst surface, which is one of the sources of catalyst deactivation. Another source of catalyst deactivation is the phase transformation of alumina to ultimately alpha-alumina and concurring support disintegration, surface cracking and/or loss of surface area. Therefore, a cooler catalyst surface temperature should also slow the rate of the phase transformation of alumina, which is thermodynamically favored by increase in temperature.

Modifying alumina (Al₂O₃) with some rare earth metals has been proven to be effective in stabilizing the surface area of modified Al₂O₃. Doping a gamma-alumina (γ-Al₂O₃) with certain metal oxides such as for example lanthanum oxide (La₂O₃) inhibits or retards the phase transformation of gamma-alumina phase to theta-alumina (θ-Al₂O₃) phase and eventually to alpha-alumina (α-Al₂O₃) phase and thus stabilizes the surface area and pore structure of the alumina material even at high calcination temperatures above 1,000° C. Not only doping the surface of gamma-alumina (γ-Al₂O₃) can stabilize the surface structure of aluminum oxide (Al₂O₃) and thus delay the phase transformation to alpha alumina, but also it can slow down the sintering at high temperatures. The driving force for sintering is the minimization of surface free energy, and thus thermodynamically, sintering is an irreversible process in which a free energy decrease is brought about by a decrease in surface area. Sintering is usually initiated on the particle surface at elevated temperatures, in a range where surface atoms become mobile and where diffusional mass transport is appreciable. The formation of Ln-Al—O mixed oxide compounds could inhibit the surface diffusion of species responsible for sintering, and thereby may be one of the key stabilization factors on an alumina surface at high temperatures.

The formation of highly thermal stable La—Al—O mixed oxide compounds such as those of hexaaluminate-type structure should also ultimately help maintain a relatively high surface area. However, it is not clear from the literature that the formation of lanthanum aluminates with hexaaluminate-like or beta-alumina structures from an alumina precursor modified with lanthanum would explain an improved thermal stability of this catalyst. Beguin et al (1991) in fact disclosed that the formation of lanthanum beta-alumina structures was associated with the loss of the stabilizing effect of lanthanum on an alumina-based material; and therefore showed that the formation of lanthanum beta-alumina structures was detrimental to the stabilization effect associated with the modification of alumina by lanthanum. Oudet et al (Applied Catalysis, 1991, vol. 75, pp. 119-132) attributed the stabilization of alumina by lanthanum to the nucleation of a cubic lanthanum aluminum oxide structure (LaAlO₃) on the surface of the alumina support, which inhibits the surface diffusion of species responsible for sintering.

As for the method of preparation, Schaper et al. (Applied Catalysis, 1983, vol. 7, pp. 211-220) who studied the influence of addition of lanthanum (0-5 mol % La₂O₃) on the thermal stability of gamma-alumina between 800 and 1,100° C., did not observe the formation of lanthanum hexaaluminate even though they observed a retardation in the sintering of gamma-alumina by the presence of perovskite-type lanthanum aluminate (LaAlO₃). The discrepancy between the formation of lanthanum hexaaluminate structures in Kato et al. (1987) and the absence of lanthanum hexaaluminate structures in Schaper et al (1983) is most likely attributed to the differences of the preparation method. Kato et al. mentioned that, with the impregnation technique, the higher concentration of lanthanum at the surface layer of the alumina phase probably tends to favor the formation of a lanthanum aluminate with a low aluminum-to-lanthanum ratio. However, according to this invention, lanthanum aluminates with a high aluminum-to-lanthanum ratio were being formed using an impregnation technique. It was quite unexpected, first to find that lanthanum hexaaluminate-like structures were formed in a catalyst support made by an impregnation technique on a lanthanum precursor on a gamma-alumina, and that, second, the presence of lanthanum hexaaluminate-like structures in a catalyst support did result in a more stable performance of the catalyst made therefrom. Therefore, this invention relates to a catalyst support, which comprises a rare earth aluminate with a high aluminum-to-rare earth molar ratio, and to catalysts made therefrom used in high temperature environments which show unexpected good thermal stability and have a greater surface area than those catalysts supported on alpha-alumina under similar operating conditions.

Herein will be described in detail, specific embodiments of the present invention, with the understanding that the present disclosure is to be considered an exemplification of the principles of the invention, and is not intended to limit the invention to that illustrated and described herein. The present invention is susceptible to embodiments of different forms or order and should not be interpreted to be limited to the specifically expressed methods or compositions or applications contained herein. In particular, various embodiments of the present invention provide a number of different combinations of features to generate high surface area supports for high temperature applications, which also comprise very good thermal stability.

### Supports

The thermally stable supports according to this invention can have different forms such as monolith or particulate or have discrete or distinct structures. The term “monolith” as used herein is any singular piece of material of continuous manufacture such as solid pieces of metal or metal oxide or foam materials or honeycomb structures. The terms “distinct” or “discrete” structures or units, as used herein, refer to supports in the form of divided materials such as granules, beads, pills, pastilles, pellets, cylinders, trilobes, extrudates, spheres or other rounded shapes, or another manufactured configuration. Alternatively, the divided material may be in the form of irregularly shaped particles. Preferably at least a majority (i.e., >50%) of the particles or distinct structures have a maximum characteristic length (i.e., longest dimension) of less than six millimeters, preferably less than three millimeters. The support is preferably in discrete structures, and particulates are more preferred.

Thermally Stable Catalyst Support Comprising a Rare earth Aluminate with Al:Ln>5:1

This invention relates to a thermally stable aluminum-based support comprising a rare earth aluminate with a high aluminum-to-rare earth molar ratio. The aluminum-to-rare earth molar ratio (Al:Ln) is greater than 5:1; preferably greater than about 10; and more preferably between about 11:1 and about 14:1. Preferably the thermally stable aluminum-based contains at least one rare earth aluminate selected from a rare earth hexaaluminate-like structure and/or a rare earth beta-alumina-like structure.

The thermally stable aluminum-based support may comprise between 1 wt % to 100 wt % of the rare earth aluminate with a high Al:Ln ratio. In preferred embodiments, the thermally stable support comprises between about 1 wt % and about 50 wt % of said rare earth aluminate; more preferably between about 5 wt % and about 45 wt % of the rare earth aluminate; and still more preferably between about 10 wt % and about 40 wt % of the rare earth aluminate. In other embodiments, the thermally stable aluminum-based catalyst support could comprise between 40 wt % and 100 wt % of the rare earth aluminate; and in some alternate embodiments, one or more rare earth aluminates with high aluminum-to-rare earth molar ratios (greater than 5:1) comprises 100 wt % of the support. The support in the catalyst could comprise between about 1 wt % and 100 wt % of said rare earth aluminate. In preferred embodiments, the support in the catalyst comprises between about 1 wt % and about 50 wt % of said rare earth aluminate. In other embodiments, the support in the catalyst could comprise more than 40 wt % of rare earth aluminate, i.e., between 40 wt % and 100 wt % of rare earth aluminate; and in some cases, the support is a rare earth aluminate or a mixture of rare earth aluminates with a molar ratio of aluminum to rare earth metal greater than 5:1. It should be readily appreciated that there are preferences within the 1 wt %-100 wt % range for the rare earth aluminate content of the support depending on the desired properties of the support.

The support should contain between about 1 wt % and about 20 wt % of rare earth metal; preferably between about 1 wt % and about 10 wt % of rare earth metal. The rare earth aluminate preferably comprises a hexaaluminate-like structure, a beta-aluminate-like structure, or combinations thereof, such as a lanthanum hexaaluminate or a lanthanum beta-alumina. The rare earth aluminate comprises a rare earth metal selected from the group consisting of lanthanum, neodymium, praseodymium, and combinations thereof. In preferred embodiments, the rare earth aluminate comprises preferably La, and optionally Sm.

It is envisioned that the rare earth aluminate with a high Al:Ln molar ratio could comprise different species of aluminates with varying Al:Ln molar ratios, as long as the different ratios are all greater than 5:1; or that the rare earth aluminate could comprise combinations of different rare earth aluminates of similar structure but comprising different rare earth metals. It should be appreciated that the rare earth aluminate could comprise any combinations of these features. For example, the support could comprise one rare earth aluminate with a Al:Ln ratio of 11:1 and an aluminate of the same rare earth metal with a higher Al:Ln ratio of 12:1. In another example, the support could comprise aluminates of two or more rare earth metals all with an Al:Ln ratio of 11:1.

The thermally stable aluminum-based support could comprise between about 1 wt % and about 20 wt % of the rare earth metal; but preferably between about 1 wt % and about 10 wt %; more preferably between about 2 wt % and about 8 wt %; and still more preferably between about 4 wt % and about 8 wt %.

This rare earth metal content corresponds to rare earth oxide loading between about 1.2 wt % and about 23 wt % of the rare earth oxide; preferably between about 1.2 wt % and about 12 wt %; more preferably between about 2.4 wt % and about 9.4 wt %; and still more preferably between about 4.7 wt % and about 9.4 wt %. This rare earth metal weight content also corresponds to rare earth oxide molar content between about 0.3 mol % and about 7 mol % of the rare earth oxide; preferably between about 0.3 mol % and about 3.5 mol % of the rare earth oxide; more preferably between about 0.6 mol % and about 2.6 mol %; and still more preferably between about 1.2 mol % and about 2.6 mol %. The rare earth oxide molar content is calculated as the ratio of the number of moles of rare earth oxide over the total number of moles of rare earth oxide and aluminum oxide.

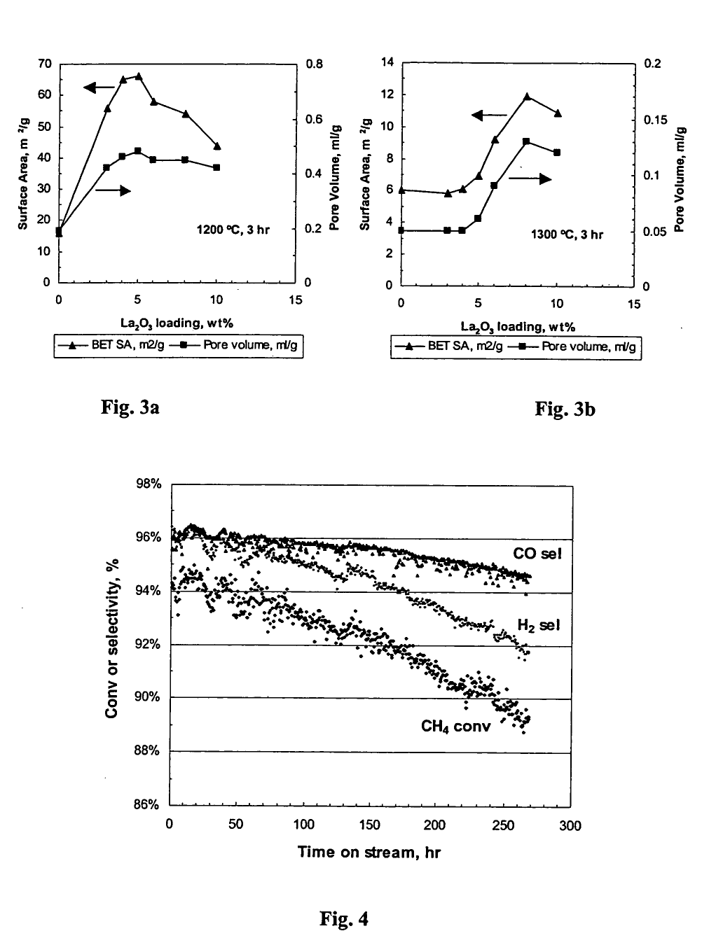

The selection of the rare earth loading on the support is dependent on the desirable range of the surface area of the support. There seems to be an optimum range of loadings for which the surface area is maximized as illustrated in FIGS. 3a and 3b. Beyond that range, thermal stability can still be achieved, but the support would have a lower surface area.

The thermally stable aluminum-based support may also comprise an oxide of a rare earth metal. For example, the rare earth aluminate with a high Al:Ln ratio might comprise only a fraction of the loaded (or applied) rare earth metal, and the other fraction of the loaded rare earth metal may form a rare earth metal oxide.

The thermally stable aluminum-based support may also comprise other rare earth aluminate structures with a low aluminum-to-rare earth metal molar ratio lower than 5:1, such as perovskite structures, monoclinic structures, or garnet structures with typically Al:Ln ratios less than 2:1. Due to the low Al:Ln molar ratio of aluminum to rare earth metal, these other rare earth aluminates can be denoted herein as a “rare earth-rich aluminate”, wherein the rare earth-lean aluminate comprises a molar ratio of aluminum to rare earth metal (Al:Ln) less than 5:1; preferably comprises an Al:Ln less than 2:1. In contrast, the rare earth aluminate comprising a higher molar ratio of aluminum to rare earth metal can be denoted herein as a “rare earth-lean aluminate”, wherein the rare earth-lean aluminate comprises a molar ratio of aluminum to rare earth metal (Al:Ln) greater than 5:1; preferably comprises a molar ratio of Al:Ln between 11:1 and 14:1.

According to another embodiment of this invention, the thermally stable catalyst support further comprises an alumina phase selected from the group consisting of alpha-alumina, theta-alumina or any combinations thereof. The rare earth aluminate with a high Al:Ln molar ratio and the alumina phase could be intimately mixed, or the rare earth aluminate could coat the alumina phase partially or completely. A surface layer comprising said rare earth aluminate with a high Al:Ln molar ratio preferably covers either partially or completely the alumina phase surface; with a complete coverage being more preferred. Therefore a person skilled in the art could select a method of preparation to achieve a well-mixed rare earth aluminate and alumina combination, such as via a sol-gel method or a co-precipitation method, or to achieve a coating of rare earth aluminate over the alumina surface, such as via impregnation or chemical vapor deposition. For the later techniques, which result in a coating of rare earth aluminate over the alumina surface, the rare earth loading should be selected such that a desired coating is achieved. For example, one can estimate the necessary amount of rare earth aluminate to completely cover the surface of the support precursor by one monolayer of said rare earth aluminate.

In preferred embodiments, the thermally stable catalyst support comprises a rare earth hexaaluminate structure, a rare earth beta-alumina structure, or combinations thereof.

The rare earth aluminate could comprise a chemical formula of LnAl_{y}O_{z}, wherein Al and O represent aluminum atoms and oxygen atoms respectively; Ln comprises lanthanum, neodymium, praseodymium, cerium, or combinations thereof; y is between 11 and 14; and z is between 18 and 23.

The rare earth aluminate could comprise a chemical formula of (Ln₂O₃).y(Al₂O₃), where Ln comprises one rare earth metal chosen from lanthanum, neodymium, praseodymium, cerium, or combinations thereof; and y is between 11 and 14.

In addition to comprising a rare earth metal, the rare earth aluminate may further comprise an element from Groups 1-17 of the Periodic Table; particularly preferred, the rare earth aluminate may further comprise nickel, magnesium, barium, potassium, sodium, manganese, a second rare earth metal (such as samarium), or any combinations thereof.

The rare earth aluminate preferably could comprise a chemical formula characterized by MAl_{y}O_{z} wherein Al and O represent aluminum atoms and oxygen atoms respectively; y=11-14; z=18-23; and wherein M preferably comprises at least one rare earth metal selected from lanthanum (La), cerium (Ce), praseodymium (Pr), neodymium (Nd), or combinations thereof. M could also comprise two or more elements from Groups 1-17 of the Periodic Table, with at least one of them being a rare earth metal. The other element is selected from Groups 1-14, and preferably comprises nickel, magnesium, barium, potassium, sodium, manganese, a second rare earth metal (such as samarium), or any combinations thereof. In preferred embodiments, M comprises preferably La, and optionally Sm. In some embodiments, M comprises both La and Sm.

In more preferred embodiments, the rare earth aluminate comprises a lanthanum hexaaluminate. The lanthanum hexaaluminates have a chemical formula of (La₂O₃).y(Al₂O₃), where La represents lanthanum, and y is between 11 and 14.

The thermally stable support may further comprise an oxide of said rare earth metal, said rare earth oxide consisting essentially of rare earth metal atoms and oxygen atoms. The oxide of said rare earth metal (Ln) preferably has a chemical formula of Ln₂O₃. It should be appreciated that in some cases, the combination of both rare earth aluminates and rare earth oxides in the catalyst support might be desirable to improve support stability.

In addition, according to one embodiment, there is an expectation that a less acidic surface layer may encourage the formation of more uniform crystallites of a catalytically active metal resulting in smaller metal crystallite sizes. The catalysts made from these thermally stable catalyst supports of the present invention are expected to have excellent stability, high activity and extended catalyst lifetimes, while maintaining desirable selectivity (e.g., hydrogen and CO selectivities), pore structure and particle size.

This rare earth modified support with enhanced thermal stability, which comprises a rare earth aluminate with a high Al:Ln molar ratio, has an initial minimum BET surface area of about 2 m²/g, preferably greater than about 5 m²/g, more preferably greater than about 7 m²/g, but no more than about 30 m²/g.

According to another embodiment of this invention, the thermally stable catalyst support comprises a rare earth-rich aluminate (e.g., with a Al:Ln molar ratio less than 5:1) and a rare earth-lean aluminate (e.g., with a low Al:Ln molar ratio greater than 5:1). The rare earth-rich aluminate and the rare earth-lean aluminate preferably comprise at least one rare earth metal in common. In alternate embodiments, the rare earth-rich aluminate and the rare earth-lean aluminate comprise different rare earth metals. The rare earth-rich aluminate may comprise a perovskite structure, a monoclinic structure, a garnet structure, or any combination of two or more thereof; preferably a perovskite structure. The rare earth-rich aluminate may have a low Al:Ln molar ratio from 1:2 to 5:1; preferably from 1:2 to 2:1; more preferably from 1:2 to 5:3; most preferably at about 1:1. The rare earth-rich aluminate of a perovskite structure preferably comprises at least one rare earth element selected form the group consisting of lanthanum (La), cerium (Ce), praesodynium (Pr), neodynium (Nd), and any combinations of two or more thereof; more preferably comprises at least one rare earth element selected form the group consisting of La, Pr, Nd, and any combinations of two or more thereof. The rare earth-lean aluminate may comprise a hexaaluminate structure, a beta-alumina structure, or combinations thereof, preferably a hexaaluminate structure. The rare earth-lean aluminate may have a high Al:Ln molar ratio greater than 5:1; preferably from 11:1 to 14:1. The rare earth-rich and rare earth-lean aluminates could be intimately mixed. Alternatively, the rare earth-rich aluminate could coat the rare earth-lean aluminate either partially or completely. The thermally stable catalyst support may further comprise an alumina phase selected from the group consisting of alpha-alumina, theta-alumina and combinations thereof. The thermally stable catalyst support, which is in the form of discrete structures (e.g., particle, particulate, bead, sphere, trilobe, pill, pellet, and the like), may contain an inner core and a surface layer which covers either partially or completely said inner core for the discrete structures, with a complete coverage being preferred, and wherein the surface layer comprises the rare earth-rich aluminate, and further wherein the inner core of the discrete structures comprises the rare earth-lean aluminate with a high Al:Ln molar ratio. The inner core of the discrete structures may further comprise an alumina phase. But, preferably, the surface layer which comprises the rare earth-rich aluminate is essentially free of alumina, such as alpha-alumina, theta alumina, or gamma-alumina. Therefore a person skilled in the art could select a method of preparation to achieve well-mixed rare earth aluminates combinations, or a well-mixed rare earth aluminates/alumina combination such as via bulk preparation methods like a sol-gel method or a co-precipitation method, or to achieve a coating of a rare earth-rich aluminate over an inner core comprising a rare earth-lean aluminate and optionally an alumina phase (e.g., alpha-alumina), such as via surface deposition methods like impregnation or chemical vapor deposition. In this embodiment, the thermally stable catalyst support preferably comprises a lanthanide content ranging from that of a rare earth-rich aluminate of a perovskite structure (with Al:Ln molar ratio of about 1:1) and that of a rare earth-lean aluminate of a hexaaluminate structure (e.g., with Al:Ln molar ratio of about 11:1 to about 14:1), wherein the range of rare earth content disclosed herein is exclusive of the endpoints. When the rare earth-rich aluminate and the rare earth-lean aluminate both comprise La, the thermally stable catalyst support preferably comprises a La content ranging from 19.2 wt % to 65 wt %, exclusive of endpoints. In other preferred embodiments, the thermally stable catalyst support comprises a La content ranging from 19.3 wt % to 64 wt %, or ranging from 19.5 wt % to 50 wt %, or ranging from 19.8 wt % to 40 wt %, or ranging from 20 wt % to 30 wt %, inclusive of endpoints and all intermediate values of these ranges. All ranges disclosed herein are combinable (e.g., ranges from 19.3 wt % to 64 wt. % desired, and about 20 wt. % to about 30 wt. %, are inclusive of the endpoints and all intermediate values of the ranges, e.g., “about 19.5 wt. % to about 30 wt. %, or about 20 wt. % to about 64 wt. %”, etc.).

High Surface Area Catalyst Support Comprising at Least Theta-Alumina

In another embodiment, a high surface area catalyst support is obtained by heat treatment of an alumina precursor with a stabilizing agent. The high surface area alumina support comprises a transition alumina comprising at least one alumina polymorph between gamma-alumina and alpha-alumina, but excluding gamma-alumina and alpha-alumina. The transition alumina preferably comprises theta-alumina and is preferably substantially free of gamma-alumina. The high surface area alumina support may further comprise alpha-alumina and/or an aluminate of said stabilizing agent. The stabilizing agent comprises at least one element selected from the group consisting of boron, silicon, gallium, selenium, rare earth metals, transition metals, and alkali earth metals, preferably selected from the group consisting of boron (B), silicon (Si), gallium (Ga), selenium (Se), calcium (Ca), zirconium (Zr), iron, (Fe), cobalt (Co), manganese (Mn), magnesium (Mg), and the rare earth elements, i.e., scandium (Sc), ytrium (Y), lanthanum (La), cerium (Ce), praseodymium (Pr), neodymium (Nd), promethium (Pm), samarium (Sm), europium (Eu), gadolinium (Gd), terbium (Th), dysprosium (Dy), holmium (Ho), erbium (Er), thulium (Tm), ytterbium (Yb), and lutetium (Lu). More preferably the stabilizing agent comprises La, Sm, Nd, Pr, Ce, Eu, Yb, Si, Ce, Mg, Ca, Mn, Co, Fe, Zr, or any combinations thereof. Most preferably, the stabilizing agent comprises La, Sm, Nd, Pr, Ce, Eu, Yb, Si, Mg, Co, or any combinations thereof. In addition, promoters may be applied to the stabilized support. Such deposited promoters may also maintain an improved dispersion on active species during catalyst preparation.

According to one embodiment of the present invention, a high surface area alumina comprising mostly theta-alumina, which is modified with a rare earth metal and/or a rare earth metal oxide, serves as an improved support for synthesis gas production catalysts used in reactors operating at high-pressure and high-temperature. The catalyst support thus obtained tends to be more resistant to phase deterioration under highly thermal conditions than gamma-alumina, and yet provide greater surface area than alpha-alumina. This thermally stable catalyst support is porous and is suitable for use in high temperature environments. This surface area is typically higher that alpha-alumina, and its thermal stability greater than gamma-alumina. It has a surface area greater than 2 meters square per gram (m²/g), preferably between about 5 m²/g and 100 m²/g, more preferably between about 20 m²/g and 80 m²/g.

One stabilized alumina support according to one embodiment of this invention preferably comprises, when fresh, at least 50% theta-alumina phase, preferably between about 60% and 75% theta-alumina; not more than about 20% alpha-alumina, and is preferably substantially free of gamma-alumina, i.e., less than about 5% gamma-alumina. In addition, the support may comprise between about 1 wt % and about 50 wt % of a rare earth aluminate with a molar ratio of aluminum to rare earth metal greater than 5:1.

### Catalysts

The present invention pertains to catalysts comprising one catalytically active metal on high surface area alumina supports or thermally stabilized aluminum-based supports, wherein the catalysts are active for the conversion of light hydrocarbons to synthesis gas. In particular, the current invention addresses the stability and durability of catalyst supports and catalysts made therefrom for use in catalytic partial oxidation reactors operating at high temperatures and pressures.

Catalysts Based on High Surface Area Supports Comprising at Least Theta-Alumina

According to one embodiment of the present invention, an alumina support comprising mostly theta-alumina, which is modified with one rare earth oxide, serves as an improved support for synthesis gas production catalysts used in reactors operating at high-pressure and high-temperature. The catalyst support thus obtained tends to be more resistant to phase deterioration under highly thermal conditions than gamma-alumina. The presence of mostly theta-alumina may result in a weaker R—O bond, where R is the catalytically active metal. The weaker R—O bond should lead to easier removal of the surface oxygen, and therefore a lower TPR temperature peak. During normal operating conditions, a weaker R—O bond would promote reduced active metal on the surface, which would favor a direct oxidation pathway (Scheme 2). In turn, this would lead to lower catalyst surface temperatures, which will slow the phase transformation of alumina to alpha-alumina (also slows deactivation).

Moreover, interactions between catalytically active metal and the alumina support are affected by the presence of the rare earth oxide. Without wishing to be bound to a particular theory, it is believed that the active metal-support interaction in catalysts supported on rare earth modified alumina, for example La₂O₃-modified Al₂O₃ is stronger than that in the similar catalysts supported on unmodified Al₂O₃, and that this strong metal-support interaction in La₂O₃-modified Al₂O₃ supported catalysts might be another reason for the unusually high catalyst stability.

The present invention also relates to improved catalyst compositions using a stabilized alumina support, as well as methods of making and using them, wherein the stabilized alumina support comprises a transition alumina phase (excluding gamma-alumina) between the low-temperature transition gamma-alumina and the high-temperature stable alpha-alumina, wherein the transition alumina is preferably theta-alumina, but could comprise low amounts of other transition alumina phases. In addition, the stabilized alumina may comprise rare earth aluminates. The catalyst is supported on a stabilized alumina with an initial minimum BET surface area of 2 m²/g, preferably greater than 5 m²/g, more preferably greater than 10 m²/g, but no more than 30 m²/g, after high temperature treatment or calcination. Preferably the stabilized alumina is modified with compounds of lanthanide metals, such as for example, compounds of lanthanum, samarium, praseodymium, cerium, or neodymium. Without wishing to be bound to a particular theory, it is believed that the metal-support interaction in catalysts supported on for example La₂O₃-modified Al₂O₃ is stronger than that in the catalyst supported on unmodified Al₂O₃, and that this strong metal-support interaction in La₂O₃-modified Al₂O₃ supported catalysts might be responsible for the unusually high catalyst stability.

Catalysts Based on Supports Comprising a Rare Earth Aluminate With a Al:Ln>5:1

According to another embodiment of the present invention, an alumina-containing support comprising a rare earth aluminate with an aluminum-to-rare earth metal molar ratio greater than 5:1, serves as an improved support for synthesis gas production catalysts used in reactors operating at high-pressure and high-temperature. The catalyst support thus obtained tends to be more resistant to phase deterioration under highly thermal conditions than gamma-alumina, and offers greater surface area than alpha-alumina. In addition to the presence of an alumina phase (either theta-alumina, alpha-alumina, or both), the presence of rare earth hexaaluminate structures is an indication that a distinct ordered aluminum structure comprising at least one rare earth metal is being formed during the preparation of the catalyst support. The formation of hexaaluminates comprising a rare earth metal during the preparation of the support described herein is believed to be another potential source of stabilization of the support, as the presence of rare earth aluminates most likely also affect the active metal-support interactions. The alumina-containing support could comprise more than 1 wt % but less than 100 wt % of said rare earth aluminate with an aluminum to rare earth metal molar ratio greater than 5:1; preferably more than 50 wt % but less than 95 wt %; more preferably more than 60 wt % but less than 90 wt %. The catalyst support which comprises a rare earth aluminate with a Al:Ln ratio greater than 5:1 may fuirther comprise another phase selected from the group consisting of a rare earth aluminate with a Al:Ln ratio less than 5:1 (e.g., perovskite; monoclinic; garnet); a rare earth oxide; an alumina phase (e.g., alpha, theta, and other transition aluminas), and any combinations of two of more thereof. The catalyst support which comprises a rare earth aluminate with a Al:Ln ratio greater than 5:1 and a rare earth aluminate with a Al:Ln ratio less than 5:1 could have a combined content of rare earth aluminates of 70% or greater; preferably a combined content of rare earth aluminates of 75% or greater; more preferably a combined content of rare earth aluminates of 70% or greater. Additionally, the catalyst support which comprises two rare earth aluminates of different Al:Ln ratios may further comprise less than 25% of any alumina phase.

Catalysts Based on High Surface Area Thermally Stable Supports

This invention also relates to a partial oxidation catalyst comprising an active ingredient selected from the group consisting of rhodium, iridium, platinum, palladium, and ruthenium; an optional promoter; and a support comprising a rare earth aluminate with a molar ratio of aluminum to rare earth metal greater than 5:1. The support in the catalyst could comprise between about 1 wt % and 100 wt % of said rare earth aluminate. A preferred support comprises at least a rare earth hexaaluminate with a Al:Ln ratio between 11:1 and 14:1. Other preferred stabilized support comprises a rare earth aluminate with a Al:Ln ratio greater than 5:1 and another phase selected from the group consisting of a rare earth aluminate with a Al:Ln ratio less than 5:1 (e.g., perovskite; monoclinic; garnet); a rare earth oxide; an alumina phase (e.g., alpha, theta, and other transition aluminas), and any combinations of two of more thereof. The stabilized support in the catalyst may further include an aluminum oxide phase such as comprising theta-alumina, alpha-alumina, or combinations thereof. The stabilized support in the catalyst may include between about 1 wt % and 50 wt % of said rare earth aluminate with a Al:Ln ratio greater than 5:1; or may include between about 50 wt % and 95 wt % of said rare earth aluminate with a Al:Ln ratio greater than 5:1. In alternate embodiments, the stabilized support in the catalyst may include two rare earth aluminates. The combined rare earth aluminates content is about 70 wt % or greater; preferably 75 wt % or greater; preferably 80 wt % or greater. In some other embodiments, the stabilized support in the catalyst may include a rare earth-lean aluminate with a Al:Ln ratio greater than 5:1 and lanthanum. In some embodiments, the support in the catalyst comprises between about 1 wt % and about 50 wt % of said rare earth aluminate. In other embodiments, the support in the catalyst could comprise more than 50 wt % of rare earth aluminate, i.e., between 40 wt % and 100 wt % of rare earth aluminate; and in some cases, the support is a rare earth aluminate or a mixture of rare earth aluminates with a molar ratio of aluminum to rare earth metal greater than 5:1, such as a lanthanum hexaaluminate or a lanthanum beta-alumina. The support could contain between about 1 wt % and about 20 wt % of rare earth metal; preferably between about 1 wt % and about 10 wt % of rare earth metal; alternatively greater than 20 wt % of rare earth metal. In some embodiments, the support comprises a rare earth content greater than 1 wt %, but lower than the stoichiometric content of the corresponding rare earth hexaaluminate structure. In other embodiments, the support comprises a rare earth content greater than the stoichiometric content of the corresponding rare earth hexaaluminate structure but lower than the stoichiometric content of the corresponding rare earth aluminate of perovskite structure, exclusive of said stoichiometric rare earth contents. In yet other embodiments, the support comprises a rare earth content greater than the stoichiometric content of the corresponding rare earth hexaaluminate structure but lower than the stoichiometric content of the corresponding rare earth aluminate monoclinic structure, exclusive of said stoichiometric rare earth contents. In still yet alternate embodiments, the support comprises a rare earth content greater than the stoichiometric content of the corresponding rare earth hexaaluminate structure but lower than the stoichiometric content of the corresponding rare earth aluminate garnet structure, exclusive of said stoichiometric rare earth contents. The rare earth aluminate preferably comprises a hexaaluminate structure, a beta-aluminate structure, or combinations thereof. The rare earth aluminate comprises a rare earth metal selected from the group consisting of lanthanum, neodymium, praseodymium, and combinations thereof. In preferred embodiments, the rare earth aluminate comprises preferably La, and optionally Sm. In some embodiments, the support could contain between about 19.2 wt % and about 65 wt % of lanthanum, exclusive of endpoints; preferably between about 19.4 wt % and about 60 wt % of lanthanum, inclusive of endpoints; more preferably between about 19.8 wt % and about 50 wt % of lanthanum, inclusive of endpoints; still more preferably between about 20 wt % and about 30 wt % of lanthanum, inclusive of endpoints; most preferably between about 20 wt % and about 25 wt % of lanthanum, inclusive of endpoints. In an embodiment, the catalyst comprises between about 50 wt % and about 96 wt % of the rare earth hexaaluminate based on the total weight of the catalyst, alternatively between about 60 wt % and about 90 wt % of the rare earth hexaaluminate.

A particularly preferred embodiment discloses a partial oxidation catalyst comprising an active ingredient selected from the group consisting of rhodium, iridium, rhenium, platinum, palladium, and ruthenium; an optional promoter; and a support comprising an alumina phase selected from the group consisting of alpha-alumina, theta-alumina, or any combinations thereof; and a rare earth aluminate with a molar ratio of aluminum to rare earth metal greater than 5:1, and wherein the support comprises between about 1 wt % and about 50 wt % of said rare earth aluminate. The rare earth aluminate preferably comprises a hexaaluminate-like structure, a beta-aluminate-like structure, or any combinations thereof. The rare earth aluminate comprises a rare earth metal selected from the group consisting of lanthanum, neodymium, cerium, praseodymium, and combinations thereof. In preferred embodiments, the rare earth aluminate comprises preferably La, and optionally Sm.

Another embodiment discloses a partial oxidation catalyst comprising an active ingredient selected from the group consisting of rhodium, iridium, and ruthenium; an optional promoter; and a rare earth aluminate, wherein the rare earth aluminate comprises an Al:Ln molar ratio between 11:1 and 14:1. The rare earth aluminate preferably has a hexaaluminate like structure, a beta-aluminate like structure, or combinations thereof. The rare earth aluminate preferably comprises a rare earth metal selected from the group consisting of lanthanum, neodymium, cerium, praseodymium, and combinations thereof. In preferred embodiments, the rare earth aluminate comprises preferably La, and optionally Sm. The active ingredient and the optional promoter are preferably supported on said rare earth aluminate with a high Al:Ln molar ratio.

Yet another embodiment discloses a partial oxidation catalyst comprising an active ingredient selected from the group consisting of rhodium, iridium, rhenium, platinum, palladium, and ruthenium; an optional promoter; and two rare earth aluminates, wherein a rare earth-rich aluminate comprises an Al:Ln molar ratio between 1:2 and 2:1 and a rare earth-lean aluminate comprises an Al:Ln molar ratio between 11:1 and 14:1. The rare earth-lean aluminate preferably has a hexaaluminate like structure, a beta-aluminate like structure, or combinations thereof. The rare earth-rich aluminate preferably has a perovskite structure. The rare earth aluminates preferably comprise a rare earth metal selected from the group consisting of lanthanum, neodymium, cerium, praseodymium, samarium, and combinations thereof. In preferred embodiments, the rare earth aluminates comprise preferably La, and optionally Sm. The active ingredient and the optional promoter are preferably supported on said rare earth aluminates either in a well-mixed matrix or in a layered arrangement with the support discrete structure, wherein the rare earth-rich aluminate is predominantly located in an outer layer of the support discrete structure (e.g., particle), said outer layer covering an inner core comprising the rare earth-lean aluminate. The catalyst may further comprise alpha-alumina. In the layered arrangement, the inner core could comprise alumina, but preferably, the outer layer is essentially free of alumina. Alternatively or additionally, the catalyst may further comprise a rare earth oxide.

All catalysts according to this invention can be used for producing synthesis gas, and therefore should comprise an active metal selected from the group consisting of metals from Groups 8, 9, or 10 of the Periodic Table, rhenium, tungsten, molybdenum, and any mixtures thereof. Preferably the catalyst used for producing synthesis gas comprises rhodium, ruthenium, iridium, platinum, palladium, rhenium, or any combinations thereof. More preferably the catalyst used for producing synthesis gas comprises rhodium, ruthenium, iridium, or any combinations thereof.

In some embodiments, the active metal may be comprised in an alloy form, preferably a rhodium alloy. Although not wishing the scope of this application to be limited to this particular theory, the Applicants believe that alloying rhodium with other metals appears to sustain the resistance of rhodium catalysts to sintering, and therefore to allow the Rh alloy catalysts to deactivate at a slower rate than syngas catalysts containing only rhodium. Suitable metals for the rhodium alloy generally include but are not limited to metals from Groups 8, 9, or 10 of the Periodic Table, as well as rhenium, tantalum, niobium, molybdenum, tungsten, zirconium and mixtures thereof. The preferred metals for alloying with rhodium are ruthenium, iridium, platinum, palladium, tantalum, niobium, molybdenum, rhenium, tungsten, cobalt, and zirconium, more preferably ruthenium, rhenium, and iridium. In accordance with the present invention, the loading of the active metal in the catalyst is preferably between 0.1 and 50 weight percent of the total catalyst weight (herein wt %).

In a preferred embodiment of the invention, the catalyst comprises rhodium as the active metal. The rhodium content in the catalyst is between about 0.1 wt % to about 20 wt %, preferably from about 0.5 wt % to about 10 wt %, and more preferably from about 0.5 wt % to about 6 wt %. In an embodiment, the rhodium content in the catalyst is between about 4 and about 10 wt. %, alternatively between about 0.1 and about 4 wt. %, and alternatively between about 0.1 and about 2 wt. %. When a rhodium alloy is used, the other metal in the rhodium alloy preferably comprises from about 0.1 wt % to about 20 wt % of the catalyst, preferably from about 0.5 wt % to about 10 wt %, and more preferably from about 0.5 wt % to about 5 wt %. The other metal in the rhodium alloy could be iridium, ruthenium, or rhenium. It is to be understood that all disclosed ranges are inclusive and combinable.

In another embodiment of the invention, the catalyst comprises ruthenium as the active metal. The ruthenium content in the catalyst is between about 0.1 to 15 wt %, preferably from about 1 to about 8 wt %, and more preferably from about 2 to about 5 wt %.

The catalyst structure employed is characterized by having a metal surface area of at least 0.5 square meters of metal per gram of catalyst structure, preferably at least 0.8 m²/g. Preferably the metal is rhodium and the rhodium surface area at least 0.5 square meters of rhodium per gram of supported catalyst, preferably at least 0.8 m²/g.

Catalyst compositions may also contain one or more promoters. In some embodiments when one active metal is rhodium, rhenium, ruthenium, palladium, platinum, or iridium, the promoter comprises an element selected from the group consisting of La, Ce, Pr, Nd, Pm, Sm, Eu, Gd, Th, Dy, Ho, Er, Tm, Yb and Lu, preferably Sm, Eu, Pr and Yb. The introduction of a lanthanide oxide, especially Sm₂O₃, on the stabilized alumina support surface before deposition of active metal is believed to further enhance the metal-support interaction, and that the active metal also disperses better on the surface of Al₂O₃ modified with La₂O₃ and/or Sm₂O₃. According to some embodiments with the use of a rhodium alloy, the presence of a promoter metal can be omitted without detriment to the catalyst activity and/or selectivity. It is foreseeable however that, in some alternate embodiments, a promoter could be added to a catalyst material comprising a rhodium alloy.

One embodiment of the present invention is more preferably directed towards syngas catalysts used in partial oxidation reactions and even more preferably used in syngas catalysts that contain solely rhodium or rhodium alloys. However, it should be appreciated that the catalyst compositions according to the present invention are useful for other partial oxidation reactions, which are intended to be within the scope of the present invention.

A preferred embodiment of this invention relates to a partial oxidation catalyst composition. The partial oxidation catalyst comprises an active ingredient selected from the group consisting of rhodium, iridium, platinum, palladium, and ruthenium; an optional promoter; and a support comprising an alumina phase selected from the group consisting of alpha-alumina, theta-alumina or any combinations thereof, and a rare earth aluminate comprising a rare earth metal, wherein the rare earth aluminate has a molar ratio of aluminum to rare earth metal greater than 5:1, and wherein the support comprises between about 1 wt % and about 50 wt % of said rare earth aluminate. The optional promoter comprises an element selected from the group consisting of La, Ce, Pr, Nd, Pm, Sm, Eu, Gd, Th, Dy, Ho, Er, Tm, Yb and Lu, preferably Sm, Eu, Pr and Yb. The preferred promoter comprises samarium.

### Methods of Support Preparation

This invention covers several embodiments of means for making catalyst supports disclosed earlier. All method embodiments comprise an application step of at least one stabilizing agent followed by a high temperature treatment. For instance, in an embodiment, a rare earth metal is applied by a surface deposition of a solution of a rare earth metal precursor onto discrete structures of an aluminum-containing precursor material. The aluminum-containing precursor material includes transition aluminas, boehmite, pseudo-boehmite, or combinations thereof. It may be calcined at a temperature sufficient to convert the aluminum atoms from the aluminum-containing precursor material to at least two rare-earth aluminates of different aluminum to rare earth metal molar ratios.

Preferably the stabilizing agent comprises a rare earth metal. The rare earth metal is selected from lanthanum, cerium, praseodymium, neodymium, samarium, or combinations. The aluminum-containing precursor may comprise at least one material selected from the group consisting of an oxide of aluminum, an aluminum salt, a salt of aluminum, an alkoxide of aluminum, a hydroxide of aluminum and any combination thereof. The aluminum-containing precursor comprises an aluminum structure selected from the group consisting of bayerite, gibbsite, boehmite, pseudo-boehmite, bauxite, gamma-alumina, delta-alumina, chi-alumina, rho-alumina, kappa-alumina, eta-alumina, theta-alumina, and any combinations thereof. The aluminum-containing precursor preferably comprises a transition alumina selected from the group consisting of gamma-alumina, delta-alumina, chi-alumina, rho-alumina, kappa-alumina, eta-alumina, theta-alumina, and combinations thereof. In a preferred embodiment, the aluminum-containing precursor comprises mostly gamma-alumina.

The gamma-alumina used as the aluminum-containing precursor in the present method of preparation of the catalyst support possesses a desired profile of physical characteristics with respect to, say, morphology and pore structure. Preferably, the gamma-alumina of the present method possesses a surface area between about 100 m²/g and about 300 m²/g; more preferably between about 120 m²/g and about 300 m²/g; but most preferably between about 120 m²/g and about 220 m²/g. The gamma-alumina as used in the present method further possesses a pore volume of at least about 0.2 ml/g. Any aluminum oxide, which meets these requirements in surface area and pore dimension, is called for the purpose of this patent gamma-alumina.

It should be understood that the aluminum-containing precursor could be pre-treated prior to calcination or application of the stabilizing agent. The pre-treatment could be heating, spray-drying to for example adjust particle sizes, dehydrating, drying, steaming or calcining. When the aluminum-containing precursor comprises an aluminum oxide such as gamma-alumina, steaming can be done at conditions sufficient to transform the aluminum oxide into a hydrated form of said aluminum oxide, such as boehmite or pseudo-boehmite or gibbsite.

The present process for preparing a stabilized alumina support may further comprise steaming the aluminum-containing precursor at conditions sufficient to at least partially transform the aluminum-containing precursor into a boehmite or pseudo-boehmite wherein steaming is defined as subjecting a given material, within the confines of an autoclave or other suitable device, to an atmosphere comprising a saturated or under-saturated water vapor at conditions of elevated temperature and elevated water partial pressure.

In one aspect, the steaming of the modified alumina precursor is preferably performed at a temperature ranging from 150° C. to 500° C., more preferably ranging from 180° C. to 300° C., a most preferably ranging from 200° C. to 250° C.; a water vapor partial pressure preferably ranging from 1 bar to 40 bars, more preferably ranging from 4 bars to 20 bars, and most preferably from 10 bars to 20 bars; and an interval of time preferably from 0.5 hour to 10 hours, and most preferably 0.5 hour to 4 hours. Preferably, under these steaming conditions, the deposited aluminum-containing precursor is at least partially transformed to at least one phase selected from the group boehmite, pseudo-boehmite and the combination thereof. A pseudo-boehmite refers to a monohydrate of alumina having a crystal structure corresponding to that of boehmite but having low cystallinity or ultrafine particle size. Alternatively, the optional steaming of the modified aluminum-containing precursor may comprise same conditions of temperature and time as above, but with a reduced water vapor partial pressure preferably ranging from 1 bar to 5 bar, and more preferably ranging from 2 bars to 4 bars.

The compound or precursor of a stabilizing agent can be in the form of salt, acid, oxide, hydroxide, oxyhydroxide, carbide, and the like. Preferably the compound or precursor of a stabilizing agent is an oxide or a salt (such as carbonate, acetate, nitrate, chloride, or oxalate). The stabilizing agent comprises at least-one element selected from the group consisting of aluminum, boron, silicon, gallium, selenium, rare earth metals, transition metals, alkali earth metals, their corresponding oxides or ions, preferably at least one element selected from the group consisting of B, Si, Ga, Se, La, Ce, Pr, Nd, Pm, Sm, Eu, Gd, Th, Dy, Ho, Er, Tm, Yb, Lu, and their corresponding oxides or ions. More preferably, the stabilizing agent comprises La, Pr, Ce, Eu, Yb, Sm, their corresponding oxides, their corresponding ions, or any combinations thereof. Preferably the compound or precursor of the stabilizing agent comprises a nitrate salt or a chloride salt, as for example only La(NO₃)₃, or Al(NO₃). It should be understood that more than one stabilizing agent or more than one compound or precursor of a stabilizing agent can be used.

The stabilizing agent can be applied to the aluminum-containing precursor by means of different techniques. For example only, application methods can be spray-drying, impregnation, co-precipitation, chemical vapor deposition, and the like. It should also be understood that any combination of techniques or multiple steps of the same technique could be used to applying a stabilizing agent.

One preferred technique for applying the stabilizing agent is impregnation, particularly incipient wetness impregnation. Generally, a stabilizing agent compound is dissolved in a solvent and a volume corresponding between about 75 and 100% of the total pore volume of a porous aluminum-containing precursor is applied to the aluminum-containing precursor. When the application is done via impregnation, a drying step at temperatures between 80° C. and 150° C. is performed on the modified aluminum-containing precursor prior to calcinations, typically to remove the solvent used in the impregnation solution.

In another embodiment, the modified aluminum-containing precursor is derived from the aluminum-containing precursor by contacting the aluminum-containing precursor with the stabilizing agent so as to form a support material and treating the support material so as to form a hydrothermally stable support. Contacting the modified aluminum-containing precursor with the stabilizing agent preferably includes dispersing the aluminum-containing precursor in a solvent so as to form a sol, adding a compound of the stabilizing agent to the sol, and spray drying the sol so as to form the support material. It should be understood that more than one stabilizing agents or more than one compound or precursors of a stabilizing agent can be added to the sol. Alternatively, one stabilizing agent can be incorporated into the support by means of the aforementioned techniques. Alternatively, two or more stabilizing agents can be incorporated into the support by means of the aforementioned techniques. The preferred stabilizing agent comprises at least one rare earth selected from the group consisting of lanthanum, cerium, praseodymium, and neodymium.

In another embodiment, a method of making a stabilized alumina support further comprises applying at least one promoter to the stabilized alumina support. In some embodiments, the promoter comprises an element selected from the group consisting of La, Ce, Pr, Nd, Pm, Sm, Eu, Gd, Tb, Dy, Ho, Er, Tm, Yb and Lu, preferably Sm, Eu, Pr and Yb. It is believed that the introduction of a lanthanide oxide, especially Sm₂O₃, on the stabilized alumina support surface before deposition of active metal seems to further enhance the metal-support interaction, and that the active metal also disperses better on the surface of stabilized support comprising an aluminum oxide and a rare earth aluminate.

Methods of Preparation of High Surface Area Catalyst Support Comprising Theta-Alumina

In particular, the present invention discloses, in one aspect, a method of making a catalyst support comprising calcining an aluminum-comprising precursor in a manner effective for converting at least a portion of the aluminum-comprising precursor to an alumina support comprising a majority of theta-alumina, and substantially free of gamma-alumina. The calcination is preferably performed after an application of a stabilizing agent to the aluminum-comprising precursor, wherein the stabilizing agent preferably comprises a rare earth metal.

In some embodiments, the calcination could be done at a high temperature greater than 800° C., but not greater than 1,300° C. Alternatively, the calcination could be done at a high temperature greater than 1,100° C., but not greater than 1,600° C., preferably between 1,200° C. and 1,500° C., preferably from about 1,250° C. to about 1,600° C., and more preferably between 1,300° C. and 1,500° C.; most preferably at about 1,375-1,425° C. The calcination temperature could be selected based on the highest temperature the catalyst would likely experience in operation, i.e. the catalytic reactor.

When the aluminum-comprising precursor comprises mainly gamma-alumina, the calcination temperature is preferably selected such that it is above the minimum temperature necessary to start the phase transformation from gamma-alumina to another transition alumina phase between the low-temperature metastable transition gamma-alumina and the high-temperature thermodynamically stable alpha-alumina, but below about the minimum temperature necessary to start the phase transformation from said transition alumina to alpha-alumina. The other transition alumina (i.e., which excludes gamma-alumina) is preferably theta-alumina, but could comprise low amounts of other transition alumina phases. In some embodiments, the calcination temperature is selected such that substantially all of the gamma-alumina phase is transformed into other alumina phases, particularly to theta-alumina or a combination of theta-alumina and alpha-alumina. For example, if a good portion of theta-alumina is desired in the support, the calcination following the application step of a rare earth compound to a gamma-alumina, should be performed at a temperature preferably between 800° C. and 1,100° C., more preferably between 900° C. and 1,000° C. Under these conditions of calcination temperatures, it is most likely that the formation of rare earth hexaaluminates would be minimized. The heat treatment is preferably performed, for a time period between 3 to 24 hours.

The calcination can be performed under an oxidizing atmosphere, either statically or under a flow of gas, preferably in static air or under a flow of a gas comprising diatomic oxygen. Stearn, either by itself or in combination with air, can also be used.

The calcination can be done at a pressure between 0 and 500 psia; preferably under atmospheric pressure (about 101 psia), or under a sub atmospheric pressure such as in a vacuum, or at slightly above atmospheric pressure (101-200 psia).

Preparation of Thermally Stable Catalyst Support Comprising a Rare Earth Aluminate with an Al:Ln>5:

An alternate preferred method comprises applying a compound of a stabilizing agent to an alumina support precursor; drying the modified alumina precursor; and treating the dried modified alumina precursor with heat in a manner effective for converting at least a portion of the aluminum-comprising material and a portion of said stabilizing agent to an aluminum-containing precursor to an aluminate of said stabilizing agent. The stabilizing agent comprises preferably a rare earth metal.

When the stabilizing agent comprises preferably a rare earth metal, the heat treatment conditions such as temperature and time are preferably selected such that at least a portion of the aluminum-comprising material is transformed to the aluminate of said rare earth metal. This rare earth aluminate could comprise a hexaaluminate structure, a beta-alumina structure, a monoclinic structure, a perovskite-type structure, or combinations thereof, but preferably, the rare earth aluminate comprises a beta-alumina structure, an hexaaluminate structure, or any combinations thereof.

In a specific example, when the aluminum-comprising precursor comprises mainly a gamma-alumina material, if the formation of rare earth aluminate with a high Al:Ln ratio (i.e., greater than 5:1) is desired in the support, the heat treatment step following the application step of a rare earth compound to said gamma-alumina material and the drying step, should be performed at a temperature preferably between 1,000° C. and 1,600° C., more preferably between 1,100° C. and 1,400° C. The heat treatment is preferably performed, for a time period between 3 to 24 hours.

The heat treatment can be performed under an oxidizing atmosphere (and in this case is called calcination), either statically or under a flow of gas, preferably in static air or under a flow of a gas comprising diatomic oxygen. Steam, either by itself or in combination with air, can also be used, as Nair et al. (Journal of American Ceramic Society, 2000, vol. 83, pp. 1942-1946) indicated that no difference in surface area was observed when the lanthanum hexaaluminate, (La₂O₃).11(Al₂O₃), was calcined in air or steam.

The holding time at high calcination temperatures is expected to be greater than a calcination time necessary for a typical phase transformation from gamma-alumina to theta-alumina to alpha-alumina, as the growth of rare earth hexaaluminates or beta-alumina structures is quite slow. Therefore one person skilled in the art should select a time period for heat treatment long enough to transform most of the rare earth compound to a rare earth hexaaluminate.

Calcining conditions can be also selected such that calcination is effective to convert a portion of the rare earth metal solution into a second rare earth aluminate but which comprises a low aluminum to rare earth metal molar ratio, such as a perovskite structure. It is possible that if the rare earth metal is not completely transformed to hexaaluminate, it could be converted in the formation of rare earth oxides and/or other rare earth aluminates, such as a perovskite type, which do not generate a higher surface area than the hexaaluminate structures are known to do. However, it should be appreciated that in some cases, the combination of rare earth aluminates with high aluminum to rare earth molar ratio (i.e., between 11:1 and 14:1 for hexaaluminate-like structure or beta-alumina structures) and rare earth aluminates with low aluminum to rare earth molar ratios (i.e., 5:3 for garnet structure, 1:1 for perovskite structure, and 1:2 for monoclinic structure) might be desirable as the former species are known to increase the surface area and the later species are known to inhibit the surface diffusion of species responsible for sintering.

Calcining can be also effective to convert a portion of the rare earth metal solution into an oxide of said rare earth metal, said rare earth oxide consisting essentially of rare earth metal atoms and oxygen atoms.

The amount of a compound of a stabilizing agent applied to an aluminum-containing precursor is sufficient so as to obtain a stabilizing agent content in the support between about 1 wt % and about 20 wt %. When the stabilizing agent comprises a rare earth metal, the amount of a compound of a rare earth compound applied to the aluminum-containing precursor is sufficient so as to obtain a rare earth content in the support between about 1 wt % and about 20 wt %, preferably between about 1 wt % and about 10 wt %, more preferably between about 3 wt % and about 8 wt %, and still more preferably between about 4 wt % and about 8 wt %. In alternate embodiments wherein the stabilizing agent comprises a rare earth, the amount of a compound of a stabilizing agent applied to an aluminum-containing precursor is sufficient so as to obtain a stabilizing agent content in the support greater than the stoichiometric rare earth content of the corresponding rare earth hexaaluminate structure but lower than the stoichiometric rare earth content of the corresponding rare earth aluminate perovskite, exclusive of said stoichiometric rare earth contents.

More specifically, a method for making a thermally stable aluminum-based support with a high surface area comprises impregnating a solution of a rare earth metal onto an aluminum-containing precursor; drying impregnated aluminum-containing precursor; and calcining in a manner effective to convert one portion of said aluminum-containing precursor to an aluminum oxide phase comprising alpha-alumina, theta-alumina, or combinations thereof; and to convert another portion of said aluminum-containing precursor with at least a fraction of said rare earth metal to a rare earth aluminate with a molar ratio of aluminum to rare earth metal greater than 5:1. After calcining, the material comprises between about 1 wt % and 100 wt % of said rare earth aluminate, preferably between about 1 wt % and about 50 wt % of said rare earth aluminate, more preferably between about 5 wt % and about 45 wt % of the rare earth aluminate, and still more preferably between about 10 wt % and about 40 wt % of the rare earth aluminate. The solution of rare earth metal comprises more than one rare earth metal. Drying is preferably performed at a temperature above 75° C., preferably between 75° C. and 150° C.

The calcination temperature is preferably selected such that at least a portion of the aluminum-containing precursor is converted to another alumina phase, so as to obtain at least a theta-alumina phase and/or alpha-alumina phase, whereas another portion of the aluminum-containing precursor is transformed with a stabilizing agent to an aluminate of said stabilizing agent.

When the stabilizing agent comprises a rare earth metal, preferably the calcination temperature is chosen to favor the formation of a solid solution of aluminum oxide and rare earth oxide, which comprises one or more rare earth aluminates. For this particular embodiment, the temperature is greater than about 1,100° C., or greater than about 1,250° C. The calcination temperature may be between about 1,100° C. and about 1,600° C.; preferably between about 1,250° C. and about 1,500° C. In some embodiments, the calcination temperature may be between about 1,300° C. and about 1,500° C.; preferably between about 1,350° C. and about 1,450° C.; more preferably between about 1,375° C. and about 1,425° C. All ranges disclosed herein are inclusive and combinable (e.g., ranges of “greater than about 1,100° C.,” with “between about 1,300° C. and about 1,500° C. desired,” and “between about 1,350° C. and about 1,450° C. more desired” are inclusive of the endpoints and all intermediate values of the ranges, e.g., “between about 1,100° C. and about 1,500° C.”, “between about 1,350° C. and about 1,500° C.,” etc.). The calcination time will depend greatly on the type of equipment used, whether commercial or lab-scale. It is preferred in the laboratory scale for 10-g to 50-g samples to use a calcination time of at least about 3 hours to achieve a content of at least 5 wt % by weight of rare earth hexaaluminate based on the weight of the support.

Calcining can be also effective to convert a portion of the rare earth metal solution into an oxide of said rare earth metal, said rare earth oxide consisting essentially of rare earth metal atoms and oxygen atoms.

Calcining can be also effective to convert a portion of the rare earth metal solution into a second rare earth aluminate but which comprises a low aluminum to rare earth metal molar ratio, such as a perovskite structure. In this embodiment, calcining can be effective to convert a portion of the rare earth metal solution into a rare earth-lean aluminate and another portion of the rare earth metal solution into a second rare earth-rich aluminate. The rare earth-lean aluminate should have an aluminum to rare earth metal molar ratio greater than 5:1, while the rare earth-rich aluminate should an aluminum to rare earth metal molar ratio less than 5:1, preferably 2:1 or less, more preferably between 1:2 and 2:1.

### Method of Catalyst Preparation

The present invention further presents a method of making a partial oxidation catalyst wherein said method comprises depositing a compound of at least one active ingredient (e.g., catalytic metal) to the stabilized support; and calcining the deposited catalyst precursor at a temperature between about 300° C. and about 1,200° C., preferably between about 300° C. and about 600° C.; preferably between about 400° C. and about 500° C.; alternatively between about 500° C. and about 1,100° C., all ranges being combinable. The stabilized support can be any of the supports disclosed earlier. The method of making a partial oxidation catalyst may optionally comprise applying a compound of one or more promoters to a stabilized support of this invention either at the same time as the compound of at least one active metal or in a separate application step (either after the active metal deposition, but preferably before the active metal deposition), in which case the promoter-applied material can be calcined at temperatures greater than 600° C., preferably between about 800° C. and about 1,400° C., more preferably between about 900° C. and about 1,300° C.

The compound of the promoter can be in the form of salt, acid, oxide, hydroxide, oxyhydroxide, carbide, and the like. Preferably the compound of the promoter is a salt. The promoter comprises at least one element selected from the group consisting of La, Ce, Pr, Nd, Pm, Sm, Eu, Gd, Th, Dy, Ho, Er, Tm, Yb, Lu, and their corresponding oxides or ions. Preferably the promoter comprises either Pr, Yb, Eu, Sm, their corresponding oxides or ions, or any combinations thereof. Preferably the compound of the promoter comprises a nitrate salt, as for example only Sm(NO₃)₃ or La(NO₃). It should be understood that more than one promoter or more than one compound or precursor of a promoter can be used.

The promoter can be deposited into the modified alumina by means of different techniques. For example only, deposition methods can be impregnation, co-precipitation, chemical vapor deposition, and the like. The preferred technique for depositing the promoter is impregnation.

When the deposition of the promoter is done via impregnation, optionally a drying step at temperatures between 75° C. and 150° C. is performed on the deposited modified alumina prior to calcination.

The compound of the active metal can be in the form of salt, acid, oxide, hydroxide, oxyhydroxide, carbide, and the like. Preferably the compound of the active metal is a salt. The active metal comprises one element selected from the group consisting of metals from Groups 8, 9, and 10 of the Periodic Table, rhenium, tungsten, and any combinations thereof. Preferably the active metal for syngas catalyst comprises rhodium, iridium, ruthenium, rhenium, or any combinations thereof. Preferably the compound of the active metal is a nitrate or a chloride salt, as for example only Rh(NO₃)₃ or RhCl₃. It should be understood that more than one active metal or more than one compound of an active metal can be used. When two active metals are used in the syngas catalyst, it is preferred that at least rhodium is selected as one metal, that the other metal is selected from the active metal list above for syngas catalyst, and that the loading of both metals is such so as to form a rhodium alloy.

The active metal can be deposited on the catalyst precursor (on promoted or unpromoted stabilized alumina support) by means of different techniques. For example only, deposition methods can be impregnation, co-precipitation, chemical vapor deposition, and the like. The preferred technique for depositing the active metal is impregnation.

When the deposition of the active metal is done via impregnation, optionally a drying step at temperatures between 75° C. and 150° C. is performed on the deposited catalyst precursor prior to calcination.

Even though the applications of both promoter and active metal to the stabilized supports are described as separate steps, the application of both promoter(s) and active metal can be done simultaneously.

After the application, drying, and calcination steps to incorporate at least one active metal and an optional promoter into the support in order to make the catalyst, an activation step may be necessary. In some embodiments, the activation step is not required; therefore, the activation step can be viewed as an optional step. The activation could comprise contacting the catalyst to a reducing atmosphere so as to convert at least a portion of the active metal to a zero-valent state. The reducing atmosphere preferably comprises hydrogen (e.g., comprising between 1% and 100% of hydrogen), but could also contain other gases (such as nitrogen, methane, carbon monoxide), which are preferably not poisons to the catalyst and/or do not chemically react with it. A mixture of hydrogen and an inert gas such as nitrogen, helium, argon, or combinations thereof would provide a suitable reducing atmosphere.

Finally, the reduction step may be followed by a post-reduction treatment at a high temperature in an inert atmosphere or under the flow of an inert gas (so as to limit the exposure of the activated catalyst to O₂). This step may be recommended if a catalyst composition comprises small amount of alpha-alumina despite the fact that the support has a rare earth content greater than the stoichiometric rare earth content of the hexaaluminate structure (LnAlₓO_{z}; x=11 to 14; y=18 to 24) of said rare earth metal.

Indeed, Applicants have observed that a post-reduction treatment at ca. 1,400° C. in an inert environment (e.g., helium) was effective to completely remove an alpha-alumina phase still present after the reduction step in an activated catalyst which containing mainly lanthanum aluminates (with a major hexaaluminate content and a small perovskite content). Although not wishing to be limiting by any particular theory, it appears that the post-reduction step (employing a temperature similar to that used for the calcination of the rare earth-deposited aluminum-containing precursor) may be effective in completely incorporating the aluminum atoms from the aluminum-containing precursor compound (e.g., gamma-Al₂O₃) into rare earth aluminates so that the catalyst composition no longer contains an alumina phase (i.e., the aluminum-containing precursor is completely converted to rare earth aluminates of different crystalline structures). The non-oxidizing atmosphere during this post-reduction step may further help convert the reminder of alumina phase to more of the rare earth-lean aluminate phase (i.e., hexaaluminate phase).

Adjustments to the conditions of the post-reduction treatment may include increasing the holding time while the catalyst composition is subjected to the post-reduction treatment temperature greater than 1,000° C., preferably greater than 1,100° C. (e.g., between 1,100° C. and 1,600° C.; or between 1,200° C. and 1,500° C.; or between 1,250° C. and 1,450° C.; or preferably about 1,400° C.); and/or adjusting the O₂ content of the post-reduction treatment to be as low as possible (i.e., below 10 ppm O₂; preferably less than 1 ppm O₂; more preferably less than 0.1 ppm O₂) by a displacement method (in which the O₂ content in the environment is slowly decreased by flowing an inert gas or a mixture of inert gases) and/or by an evacuation method (in which the environment is first evacuated and then replaced with an inert gas or inert gas mixtures). A preferred inert gas for the post-reduction treatment includes helium, nitrogen, argon or combinations thereof.

### Methods of Producing Synthesis Gas

According to the present invention, a syngas reactor can comprise any of the synthesis gas technology and/or methods known in the art. The hydrocarbon-containing feed is almost exclusively obtained as natural gas. However, the most important component is generally methane. Natural gas comprise at least 50% methane and as much as 10% or more ethane. Methane or other suitable hydrocarbon feedstocks (hydrocarbons with four carbons or less) are also readily available from a variety of other sources such as higher chain hydrocarbon liquids, coal, coke, hydrocarbon gases, etc., all of which are clearly known in the art. Preferably, the feed comprises at least about 50% by volume methane, more preferably at least 80% by volume, and most preferably at least 90% by volume methane. The feed can also comprise as much as 10% ethane. Similarly, the oxygen-containing gas may come from a variety of sources and will be somewhat dependent upon the nature of the reaction being used. For example, a partial oxidation reaction requires diatomic oxygen as a feedstock, while steam reforming requires only steam. According to the preferred embodiment of the present invention, partial oxidation is assumed for at least part of the syngas production reaction.

Regardless of the source, the hydrocarbon-containing feed and the oxygen-containing feed are reacted under catalytic conditions. Improved catalyst compositions in accordance with the present invention are described herein. They generally are comprised of a catalytic metal, some alloyed, that has been reduced to its active form and with one or more optional promoters on a stabilized aluminum-based support.

It has been discovered that the stabilization of an aluminum-based support by the presence of at least one rare earth aluminate with a molar ratio of aluminum-to-rare earth metal greater than 5:1 results in obtaining a catalytic support suitable for high-temperature reactions such as syngas production via partial oxidation.

Thus this invention relates to a method for making synthesis gas comprising converting a gaseous hydrocarbon stream and an oxygen-containing stream over a partial oxidation catalyst, to make a product stream comprising CO and H₂, wherein said partial oxidation catalyst includes an active ingredient comprising rhodium, iridium, platinum, palladium, ruthenium, or combinations thereof, and a support comprising a rare earth aluminate, said rare earth aluminate having a molar ratio of aluminum to rare earth metal greater than 5:1. The rare earth aluminate preferably has a molar ratio of aluminum to rare earth metal between 11:1 and 14:1. The rare earth aluminate preferably has a hexaaluminate-like structure, a beta-alumina like structure, or combinations thereof. The catalytic support can contain from about 1 wt % to 100 wt % of the rare earth aluminate; preferably more than about 1 wt % but less than 100 wt % of the rare earth aluminate. In some preferred embodiments, the catalytic support contains from about 1 wt % to about 50 wt % of the rare earth aluminate. In other preferred embodiments, the catalytic support contains from about 50 wt % to about 95 wt % of the rare earth aluminate; or from about 60 wt % to about 90 wt % of the rare earth aluminate. In other embodiments, the thermally stable aluminum-based catalyst support could comprise between 40 wt % and 100 wt % of the rare earth aluminate. In some alternate embodiments, the support is a rare earth aluminate or a mixture of rare earth aluminates with an aluminum-to-rare earth metal molar ratio greater than 5:1, such as a lanthanum hexaaluminate-like material or a lanthanum beta-alumina-like material. In some embodiments, the thermally stable aluminum-based catalyst support could comprise at least two rare earth aluminates and their combined content could be between 70 wt % and 100 wt %, or between 75 wt % and 99 wt %; or between 80 wt % and 95 wt % of the total weight of the support; all ranges being inclusive and combinable. In some preferred embodiments, the support comprises a rare earth-rich aluminate with an aluminum-to-rare earth metal molar ratio less than 5:1 (e.g., lanthanum aluminate perovskite with an aluminum-to-rare earth metal molar ratio of 1:1) and a rare earth-lean aluminate with an aluminum-to-rare earth metal molar ratio greater than 5:1 (e.g., lanthanum hexaaluminate or lanthanum beta-alumina with an aluminum-to-rare earth metal molar ratio between 11:1 and 14:1).

In addition, it has been discovered that the stabilization of an aluminum-based support by the addition of at least one stabilizing agent to a transition alumina between gamma-alumina and alpha-alumina (but excluding gamma-alumina) results in a high-surface area catalytic support suitable for high-temperature reactions.

This invention also relates to a method for making synthesis gas comprising converting a gaseous hydrocarbon stream and an oxygen-containing stream over a partial oxidation catalyst, to make a product stream comprising CO and H₂, wherein said partial oxidation catalyst includes an active ingredient comprising rhodium, iridium, platinum, palladium, ruthenium, or combinations thereof; and a support comprising a transition alumina excluding gamma-alumina, and at least one stabilizing agent. The transition alumina in the support preferably comprises theta-alumina. The support may also comprise alpha-alumina. The stabilizing agent is preferably a rare earth metal. The stabilizing agent more preferably includes a lanthanide metal selected from the group consisting of lanthanum, cerium, neodymium, praseodymium, samarium, and combinations thereof, but may further include any element from Groups 1-14 of the Periodic Table (new IUPAC notation) such as an alkali metal, an alkali earth metal, an additional rare earth metal, or a transition metal.

The syngas catalyst compositions according to the present invention comprise an active metal selected from the group consisting of metals from Group 8, 9, and 10 of the Periodic Table, rhenium, tungsten, and any combinations thereof, preferably a metal from Group 8, 9, and 10 of the Periodic Table and any combinations thereof, more preferably rhodium, iridium, ruthenium, or combinations thereof.

In some embodiments when the active metal is rhodium, rhodium is comprised in a high melting point alloy with another metal. It has been discovered that in addition to the enhanced thermal stability of the support, the high melting point rhodium alloys used in some of these syngas catalysts confer additional thermal stability than non-alloy rhodium catalysts, which leads to enhanced ability of the catalyst to resist various deactivation phenomena.

It is well known that during syngas reactions, several undesired processes, such as coking (carbon deposition), metal migration, and sintering of metal and/or the support, can occur and severely deteriorate catalytic performance. The catalyst compositions of the present invention are better able to resist at least one of these phenomena over longer periods of time than prior art catalysts. As a consequence, these novel rhodium-containing catalysts on stabilized alumina comprising mainly theta alumina can maintain high methane conversion as well as high CO and H₂ selectivity over extended periods of time with little to no deactivation of the syngas catalyst.

The support structure of these catalysts can be in the form of a monolith or can be in the form of divided or discrete structures or particulates. Particulates are preferred. Small support particles tend to be more useful in fluidized beds. Preferably at least a majority (i.e., >50%) of the particles or distinct structures have a maximum characteristic length (i.e., longest dimension) of less than six millimeters, preferably less than three millimeters. According to some embodiments, the divided catalyst structures have a diameter or longest characteristic dimension of about 0.25 mm to about 6.4 mm (about 1/100″ to about ¼″), preferably between about 0.5 mm and about 4.0 mm. In other embodiments they are in the range of about 50 microns to 6 mm.

The hydrocarbon feedstock and the oxygen-containing gas may be passed over the catalyst at any of a variety of space velocities. Space velocities for the process, stated as gas hourly space velocity (GHSV), are in the range of about 20,000 hr⁻¹ to about 100,000,000 hr⁻¹, more preferably of about 100,000 hr⁻¹ to about 10,000,000 hr⁻¹, still more preferably of about 200,000 hr⁻¹ to about 2,000,000 hr⁻¹, most preferably of about 400,000 hr⁻¹ to about 1,000,000 hr⁻¹. Although for ease in comparison with prior art systems space velocities at standard conditions have been used to describe the present invention, it is well recognized in the art that residence time is the inverse of space velocity and that the disclosure of high space velocities corresponds to low residence times on the catalyst. “Space velocity,” as that term is customarily used in chemical process descriptions, is typically expressed as volumetric gas hourly space velocity in units of hr⁻¹. Under these operating conditions a flow rate of reactant gases is maintained sufficient to ensure a residence or dwell time of each portion of reactant gas mixture in contact with the catalyst of no more than 200 milliseconds, preferably less than 50 milliseconds, and still more preferably less than 20 milliseconds. A contact time less than 10 milliseconds is highly preferred. The duration or degree of contact is preferably regulated so as to produce a favorable balance between competing reactions and to produce sufficient heat to maintain the catalyst at the desired temperature.

In order to obtain the desired high space velocities, the process is operated at atmospheric or super atmospheric pressures. The pressures may be in the range of about 100 kPa to about 4,000 kPa (about 1-40 atm), preferably from about 200 kPa to about 3,200 kPa (about 2-32 atm).

The process is preferably operated at a temperature in the range of about 350° C. to about 2,000° C. More preferably, the temperature is maintained in the range of about 400° C. to about 1,600° C., as measured at the reactor outlet. Still more preferably, the temperature is maintained in the range of about 800° C. to about 1,200° C., as measured at the reactor outlet. In some instances, the temperature is maintained in the range of about 850° C. to about 1,100° C., as measured at the reactor outlet.

The catalysts of the present invention should maintain hydrocarbon conversion of equal to or greater than about 85%, preferably equal to or greater than about 90% after 100 hours of operation when operating at pressures of greater than 2 atmospheres. Likewise, the catalysts of the present invention should maintain CO and H₂ selectivity of equal to or greater than about 85%, preferably equal to or greater than about 90% after 100 hours of operation when operating at pressures of greater than 2 atmospheres.

The synthesis gas product contains primarily hydrogen and carbon monoxide, however, many other minor components may be present including steam, nitrogen, carbon dioxide, ammonia, hydrogen cyanide, etc., as well as unreacted feedstock, such as methane and/or oxygen. The synthesis gas product, i.e. syngas, is then ready to be used, treated, or directed to its intended purpose. The product gas mixture emerging from the syngas reactor may be routed directly into any of a variety of applications, preferably at pressure. For example, in the instant case, some or all of the syngas can be used as a feedstock in subsequent synthesis processes, such as Fischer-Tropsch synthesis, alcohol (particularly methanol) synthesis, hydrogen production, hydroformylation, or any other use for syngas. One preferred such application for the CO and H₂ product stream is for producing via the Fischer-Tropsch reaction synthesis higher molecular weight hydrocarbons, such as C₅₊ hydrocarbons.

Syngas is typically at a temperature of about 600° C.-1,500° C. when leaving a syngas reactor. The syngas must be transitioned to be useable in a Fischer-Tropsch or other synthesis reactors, which operate at lower temperatures of about 160° C. to 400° C. The syngas is typically cooled, dehydrated (i.e., taken below 100° C. to knock out water) and compressed during the transition phase. Thus, in the transition of syngas from the syngas reactor to for example a Fischer-Tropsch reactor, the syngas stream may experience a temperature window of 50° C. to 1,500° C.

In addition, the present invention contemplates an improved method for converting hydrocarbon gas to liquid hydrocarbons using the novel catalyst compositions described herein for synthesis gas production from light hydrocarbons. Thus, the invention also relates to processes for converting hydrocarbon-containing gas to liquid products via an integrated syngas to Fischer-Tropsch, methanol or other processes.

### Hydrocarbon Synthesis from Synthesis Gas

The synthesis gas (a mixture of hydrogen and carbon monoxide) produced by the use of catalysts as described above is assumed to comprise at least a portion of the feed to a Fischer-Tropsch reactor. The Fischer-Tropsch reactor can comprise any of the Fischer-Tropsch technology and/or methods known in the art. The feed to the Fischer-Tropsch comprises a synthesis gas (or syngas) with a hydrogen to carbon monoxide molar ratio between 0.67:1 and 5:1 but is generally deliberately adjusted to a desired ratio of between about 1:4:1 to 2.3:1, preferably approximately 1.7:1 to 2.2:1. The syngas is then contacted with a Fischer-Tropsch catalyst. Fischer-Tropsch catalysts are well known in the art and generally comprise a catalytically active metal and a promoter. The most common catalytic metals are metals from Groups 8, 9, 10 of the Periodic Table, such as cobalt, nickel, ruthenium, and iron or mixtures thereof. They may also comprise a support structure. The support is generally alumina, titania, zirconia, silica, or mixtures thereof. In some embodiments, it is envisioned that the Fischer-Tropsch catalyst may be supported on a stabilized alumina as described in this invention. Fischer-Tropsch reactors use fixed and fluid type conventional catalyst beds as well as slurry bubble columns. The literature is replete with particular embodiments of Fischer-Tropsch reactors and Fischer-Tropsch catalyst compositions. As the syngas feedstock contacts the catalyst, the hydrocarbon synthesis reaction takes place. The Fischer-Tropsch product contains a wide distribution of hydrocarbon products from C₅ to greater than C₁₀₀. The Fischer-Tropsch process is typically run in a continuous mode. In this mode, the gas hourly space velocity through the reaction zone typically may range from about 50 hr⁻¹ to about 10,000 hr⁻¹, preferably from about 300 hr⁻¹ to about 2,000 hr⁻¹. The gas hourly space velocity is defined as the volume of reactants per time per reaction zone volume (the volume of reactant gases is at standard pressure of 1 atm or 101 kPa and standard temperature of 0° C.; the reaction zone volume is defined by the portion of the reaction vessel volume where reaction takes place and which is occupied by a gaseous phase comprising reactants, products and/or inerts; a liquid phase comprising liquid/wax products and/or other liquids; and a solid phase comprising catalyst). The reaction zone temperature is typically in the range from about 160° C. to about 300° C. Preferably, the reaction zone is operated at conversion promoting conditions at temperatures from about 190° C. to about 260° C., more preferably between about 200° C. and about 230° C. The reaction zone pressure is typically in the range of about 80 psia (552 kPa) to about 1,000 psia (6895 kPa), more preferably from 80 psia (552 kPa) to about 800 psia (5515 kPa), and still more preferably, from about 140 psia (965 kPa) to about 750 psia (5170 kPa). Most preferably, the reaction zone pressure is from about 140 psia (965 kPa) to about 500 psia (3447 kPa).

### DEFINITIONS

For purposes of the present disclosure, certain terms are intended to have the following meanings.

“Active metal” refers to any metal that is present on a catalyst that is active for catalyzing a particular reaction. Active metals may also be referred to as catalytic metals.

A “promoter” is one or more substances, such as a metal or a metal oxide or metal ion that enhances an active metal's catalytic activity in a particular process, such as a CPOX process (e.g., increase conversion of the reactant and/or selectivity for the desired product). In some instances, a particular promoter may additionally provide another function, such as aiding in dispersion of active metal or aiding in stabilizing a support structure or aiding in reduction of the active metal.

A “stabilizing agent” is one or more substances, comprising an element from the Periodic Table of Elements, or an oxide or ion of such element, that modifies at least one physical property of the support material that it is deposited onto, such as for example structure of crystal lattice, mechanical strength, and/or morphology.

A rare earth “aluminate” refers to compounds or related materials in the system Ln-Al—O, where Ln, Al and O represent the rare earth metal, aluminum, oxygen, respectively.

A “rare earth-rich aluminate” refers to a rare earth aluminate which comprises an aluminum to rare earth molar ratio (Al:Ln) of less than 5:1, preferably less than 2:1, more preferably between 1:2 and 2:1. Examples of rare earth-rich aluminates include perovskite structures (Al:Ln of 1:1); monoclinic structures (Al:Ln of 1:2); and garnet structures (Al:Ln of 5:3). The rare earth-rich aluminate contains at least one rare earth cation. A rare earth-rich aluminate may contain one other cation of another rare earth metal, or a cation of any element from Groups 1-14 of the Periodic Table (new IUPAC notation).

A “rare earth-lean aluminate” refers to a rare earth aluminate which comprises an aluminum to rare earth molar ratio of greater than 5:1, preferably between 11:1 and 14: 1. Examples of rare earth-lean aluminates include hexaaluminate structures; cation-substituted hexaaluminate structures; beta-aluminate structures; and cation-substituted beta-aluminate structures. The rare earth-lean aluminate contains at least one rare earth cation. A rare earth-lean aluminate may contain one other cation of another rare earth metal, or a cation of any element from Groups 1-14 of the Periodic Table (new IUPAC notation).

With respect to the catalytic reaction such as partial oxidation of light hydrocarbons such as methane, ethane, any combinations of two or more C₁-C₅ alkanes, or natural gas to produce synthesis gas or conversion of synthesis gas to hydrocarbons, references to “catalyst stability” refer to maintenance of at least one of the following criteria: level of conversion of the reactants, productivity, selectivity for the desired products, physical and chemical stability of the catalyst, lifetime of the catalyst on stream, and resistance of the catalyst to deactivation.

A compound of an element is a chemical entity that contains the atoms of said element (whether the element is a catalytically active metal, a promoter, or a stabilizing agent).

A transition alumina is typically defined as any crystalline aluminum oxide phase which is obtained by dehydration from an aluminum hydrate precursor such as boehmite or pseudo-boehmite, gibbsite, or bayerite, to ultimately the thermodynamically stable phase of alumina, alpha-alumina. Transition aluminas comprise gamma-alumina, theta-alumina, delta-alumina, eta-alumina, rho-alumina, chi-alumina, and kappa-alumina.

Gamma-alumina and theta-alumina are two metastable phases of aluminum oxide observed along the dehydration sequence of boehmite upon thermal treatment before conversion to the final product alpha-alumina (see for example, ‘Transformation of gamma-alumina to theta-alumina’ by Cai, Physical Review Letters, 2002, vol. 89, pp. 235501).

Theta-alumina is a metastable phase of alumina with aluminum atoms both octahedrally and tetrahedrally coordinated. The local cation coordinations in theta-alumina are close to those in gamma-alumina but different from alpha-alumina. Theta-alumina has an indirect energy band gap, which is 1.6 eV smaller than that of alumina. The linear optical properties of theta-alumina are very close to those of alpha-alumina. [Mo and Ching (1998), Session W19, 1998 March Meeting of The American Physical Society, Mar. 16-20, 1998, Los Angeles, Calif.].

### EXAMPLES

The invention having been generally described, the following examples are given as particular embodiments of the invention and to demonstrate the practice and advantages hereof. It is understood that the examples are given by way of illustration and are not intended to limit the specification or the claims to follow in any manner.

An aluminum-containing precursor was obtained as gamma-Al₂O₃ spheres from Davison, with the following characteristics: a size in the range of 1.2 to 1.4 mm (average diameter of 1.3 mm.), a bulk density of 0.44 g/ml, a surface area and pore volume measure with N₂ adsorption of 143 m²/g and 0.75 ml/g respectively. For a control, supports using γ-Al₂O₃ spheres were formed using no modifier by calcination at different calcination temperatures between 600 and 1,300° C. for 3 hours. For generating lanthanum-modified supports, Al₂O₃ spheres were impregnated with a lanthanum nitrate (La(NO₃)₃) solution, dried in an oven at 120° C. overnight, and then calcined at different calcination temperatures between 600 and 1,300° C. for 3 hours. The γ-Al₂O₃ spheres were impregnated with an aqueous solution containing desired amount of La(NO₃)₃ so that the lanthanum oxide (La₂O₃) amount in the final material after drying and calcinations is approximately 3 wt % or 10 wt % lanthanum oxide by weight of the total support (this corresponds to a weight content of about 2.56 wt % and 8.53 wt % La and a molar content of 0.94 mol % and 3.1 mol % of La₂O₃, respectively).

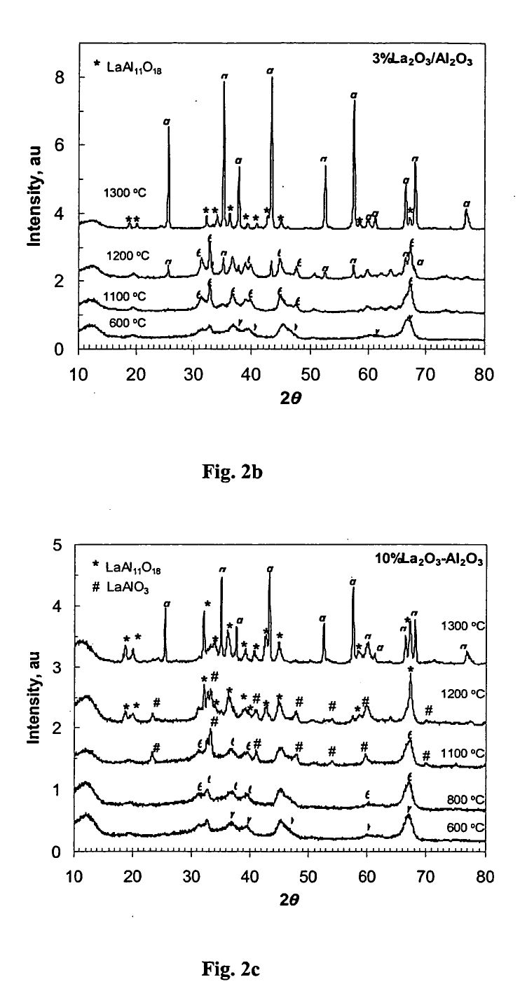

FIGS. 2a, 2b and 2c represent the X-Ray Diffraction patterns of several support materials comprising respectively no lanthanum, 3 wt % La₂O₃ and 10 wt % La₂O₃, all obtained after an impregnation and a 3-hour calcination at different temperatures. When one compares the XRD traces of undoped alumina (FIG. 2a) and the 3 wt % La₂O₃ on alumina in (FIG. 2b) that were calcined at 1,100° C. or 1,200° C., it is noted that α-Al₂O₃ phase was present in higher percentage in undoped alumina (Al₂O₃) than in 3 wt % La on alumina (3 wt % La₂O₃/Al₂O₃). The α-Al₂O₃ phase was detected already in the undoped Al₂O₃ calcined at 1,100° C. while α-Al₂O₃ peaks in the 1,100° C. calcined 3 wt % La₂O₃/A₂O₃ were negligible. The difference in Al₂O₃ phase compositi those two samples is more obvious for the 1,200° C. calcinated samples—α phase is the predominant phase in undoped Al₂O₃ while θ-Al₂O₃ is the main phase in 3 wt % La₂O₃/A₂O₃ sample, suggesting a lanthanum dopant with 3 wt % La₂O₃ loading is effective in preventing θ phase from transforming into α phase at 1,200° C. Nevertheless, the thermodynamically stable α phase becomes the dominant phase in both undoped and 3 wt % La₂O₃/A₂O₃ after calcination at 1,300° C. In order to further retard the α-Al₂O₃ phase formation and to maintain a relatively high surface area after 1,300° C. calcination, the La₂O₃ doping level needed to be increased. The XRD results obtained with 10% La₂O₃/Al₂O₃ samples calcined at different temperatures indicate that La—Al—O mixed oxide compounds were formed upon calcination at high temperatures (FIG. 2c). The presence of perovskite -structured LaAlO₃ compound was detected in the 1,100° C. calcined sample. A hexaluminate-type La—Al—O compound, LaAl₁₁O₁₈ emerged after 1,200° C. calcination at the expense of LaAlO₃, which completely disappeared in the 1,300° C. calcined 10% La₂O₃/Al₂O₃. Based on the XRD results in FIG. 2c, we conclude that the sequences of La₂O₃+Al₂O₃ reaction at high temperatures follow:

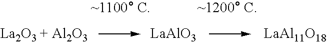

For the 1,200° C.-calcined 10% La₂O₃/Al₂O₃ sample, the intensities of XRD diffraction peaks from α-Al₂O₃ are much lower than those in the 1,200° C.-calcined 3% La₂O₃/Al₂O₃ sample, suggesting the retardation of α-Al₂O₃ formation is more effective at higher La₂O₃ doping levels. Moreover, when comparing the XRD traces of 1,300° C.-calcined sample in FIG. 2b and FIG. 2c, one may notice that the α-Al₂O₃ phase in the 10% La₂O₃/Al₂O₃ sample is not as predominant as in 3% La₂O₃/Al₂O₃ (FIG. 2c). It seems that there is an absence of dominant α-Al₂O₃ phase and the presence of more thermal stable LaAl₁₁O₁₈ in the 1,300° C. calcined samples (FIG. 2c) in the 10% La₂O₃/Al₂O₃ support than those of unmodified Al₂O₃ and 3% La₂O₃/Al₂O₃.

In order to find the optimum La₂O₃ doping level to stabilize the Al₂O₃ structure, La₂O₃ doping level was varied from 3 wt % to 10 wt %. The BET surface area and pore volume of La₂O₃/Al₂O₃ of different La₂O₃ doping levels were shown in FIGS. 3a and 3b, respectively. Doping Al₂O₃ with 3 wt % La₂O₃ dopant retards Al₂O₃ phase transition to a phase upon thermal treatment with limited success in retaining the surface area and pore volume after calcination at 1,200° C. or higher. Thermal sintering, formation of α phase and the consequent dramatic decrease in surface area and pore structure, are inevitable under extremely severe condition (e.g., at 1,300° C., FIG. 2a and FIG. 2b). Increasing the La₂O₃ dopant level above 3 wt % further helps to stabilize Al₂O₃ structure. The results in FIGS. 3a and 3b indicate that the optimum La loadings to achieve the highest surface area and pore volume of La₂O₃ modified Al₂O₃ are dependent of calcination temperature. For 1,200° C. calcined samples, the largest surface area and pore volume was found to be that of 5 wt % La₂O₃/Al₂O₃ (FIG. 3a). Optimum surface area/pore volume was achieved with 8 wt % La₂O₃ loading with 1,300° C. calcined La₂O₃/Al₂O₃ samples (FIG. 3b). With a La₂O₃ doping level higher than those optimum values, the surface area and pore volume decrease.

Thus, support formulation comprising 6-8 wt % La₂O₃ (corresponding respectively to ca. 5.1-6.8 wt % La and ca. 1.88-2.5 mol % La₂O₃) in the aluminum oxide matrix and calcined at 1,300° C. seemed to provide higher surface area than the unmodified alumina structure or those modified with higher or lower La loadings.

### Catalyst Example

The γ-Al₂O₃ spheres described above were impregnated with an aqueous solution containing desired amount of lanthanum nitrate [La(NO₃)₃] so that the lanthanum oxide [La₂O₃] amount in the final material after drying and calcinations is approximately 3% by weight. The Al₂O₃ spheres impregnated with the La(NO₃)₃ solution were dried in oven at 120° C. overnight and then calcined at 1,200° C. for 3 hours to form a La₂O₃-modified Al₂O₃ support material. The La₂O₃—Al₂O₃ spheres (Support Example S) were then subjected to samarium addition.

The La₂O₃-modified Al₂O₃ support material obtained as EXAMPLE 1 was impregnated with a samarium nitrate [Sm(NO₃)₃] solution. The material was dried in oven for overnight at 120° C. and then calcined at 1,100° C. for 3 hours to form a samarium-promoted catalyst support (Promoted Support Example PS). The Sm content in the catalyst was 4 wt % Sm₂O₃ in the final material after drying and calcinations.

The promoted catalyst support calcined was then impregnated with a rhodium chloride [RhCl₃] solution and the catalyst precursor was dried in oven for overnight at 120° C., calcined at 900° C. for 3 hours, and then reduced in H₂ at 600° C. for 3 hours to generate some metallic rhodium form before being charged into the reactor to as to form a catalyst (Catalyst Example C). The Rh metal content in the catalyst was 4% by weight again determined by mass balance.

Table 1 lists the alumina phase content, the rare earth aluminate content, BET surface areas, pore volume, average pore diameter, average pore volume and average pore diameter both measured by the BJH desorption method using N₂ as the adsorptive of the modified alumina catalyst support, the promoted modified support and the catalyst made therefrom.

The characterization of the transition alumina support was done by Rietveld X-Ray Diffraction. Rietveld XRD uses a modeling tool, which can extrapolate the percentage of different alumina phases based on crystalline raw data from XRD. The Rietveld neutron profile refinement method is disclosed by Rietveld (J. Appl. Cryst., 1969, vol. 2, pp. 65-71) and the quantitative analysis of minerals using the full powder diffraction profile using the Rietveld modeling are described in Bish & Howard (J. Appl. Cryst., 1988, vol. 21, pp. 86-91). The Rietveld neutron profile of gamma-alumina and theta-alumina disclosed in Zhou et al. (Acta Cryst., 1991, vol. B47, pp. 617-630) were used as a reference for the determination of the alumina phase content in the samples.

Surface area and pore size distribution are obtained on a Micromeritics TriStar 3000 analyzer after degassing the sample at 190° C. in flowing nitrogen for five hours. Surface area is determined from ten points in the nitrogen adsorption isotherm between 0.05 and 0.3 relative pressure and calculating the surface area by the standard BET procedure. Pore size distribution is determined from a minimum of 30 points in the nitrogen desorption isotherm and calculated using the BJH model for cylindrical pores. The instrument control and calculations are performed using the TriStar software and are consistent with ASTM D3663-99 “Surface Area of Catalysts and Catalyst Carriers”, ASTM D4222-98 “Determination of Nitrogen Adsorption and Desorption Isotherms of Catalysts by Static Volumetric Measurements”, and ASTM D4641-94 “Calculation of Pore Size Distributions of Catalysts from Nitrogen Desorption Isotherms”. The initial surface area (A) of the catalyst is the surface area of the catalyst structure prior to contact of reactant gas. The pore volume (V) of the catalyst (N₂ as adsorptive) is measured and calculated using the method described above. Average pore size (diameter) based on N₂ adsorptive is calculated as 4V/A.

For the alumina material modified with La (Example S), calcinations at 1,200° C. resulted in a mixture of gamma-Al₂O₃ (24 wt %), theta-Al₂O₃ (66 wt %) and alpha-Al₂O₃ (10 wt %). Addition of samarium to Example S and calcination at 900° C. (Example PS) produced a mixture of theta-Al₂O₃ (88wt %) and alpha-Al₂O₃ (12 wt %), as the gamma-alumina phase seemed to be no longer present. The addition of rhodium to Example PS and subsequent calcination at 600° C. (Example C) consisted of theta-Al₂O₃ (87 wt %) and alpha-Al₂O₃ (13 wt %). Therefore, Examples PS and C had similar alumina phase composition.

From Table 1, it is noted that calcination at 1,200° C. completely transformed gamma-Al₂O₃ to theta-Al₂O₃ or alpha-Al₂O₃. One also anticipates that a longer calcination time at a given temperature would also result in transforming more gamma-Al₂O₃ to theta-Al₂O₃.

TABLE 1
Surface area, pore volume, average pore diameter, and alumina phase content of
support and catalyst examples after different calcination temperatures of the support.

| | | | | | | | Estimated alumina | | |
|---|---|---|---|---|---|---|---|---|---|
| | | | | | | | (Al₂O₃) content^{c} | | |
| | | Support Calc. | BET SA, | Pore vol., | Avg. Pore | ^{d}LnAl_{y}O_{z} | (wt %) | | |
| Ex | Composition | Temp., C. | m²/g | ml/g | size, nm | With (wt %) | γ | θ | α |
| S | La₂O₃—Al₂O₃ | 1,200 | 56 | 0.42 | 23 | 7% | 21 | 63 | 9 |
| ^{a}PS | 4% Sm/ | 1,200 | — | — | — | 20% | 0 | 68 | 10 |
| | La₂O₃—Al₂O₃ | | | | | | | | |
| ^{b}C | 4% Rh/4% Sm/ | 1,200 | 39 | 0.35 | 30 | 18% | 0 | 66 | 10 |
| | La₂O₃—Al₂O₃ | | | | | | | | |

^{a}this sample also contained 2% of samarium oxide
^{b}this sample also contained 2% of samarium oxide and 4% rhodium
^{c}γ, θ, and α refer to gamma-alumina, theta-alumina, and alpha-alumina respectively
^{d}LnAl_{y}O_{z} represents a rare earth hexaaluminate-like structure with y = 11-12 and z = 18-19, and Ln represents lanthanum, or samarium, or combinations thereof.

As the phase transformations of Al₂O₃ follow gamma→theta→alpha with progressive heating, the calcination temperature also has a great impact on the porous structure and support characteristics. A significant difference in surface area (143 m²/g vs. 56 m²/g) and pore volume (0.75 ml/g vs. 0.44 ml/g) in unmodified untreated alumina material and Example S was observed, concurrently to the appearance of a good portion of theta-alumina phase and some alpha-alumina phase.

It is worth mentioning that additional XRD data using Rietvel modeling (Rietveld, J. Appl. Cryst., 1969, vol. 2, pp. 65-71; Bish & Howard, J. Appl. Cryst., 1988, vol. 21, pp. 86-91; Taylor, Powder Diffraction, 1991, vol. 6, pp. 2-9) indicated that there was no distinguished phase of La₂O₃ found in any of the samples, instead, two forms of rare earth alumina solid solution were found matching the spectrum. One is a random form, alumina maintained gamma or theta structures with some of aluminum atoms in the lattices randomly replaced by rare earth metal atoms. All gamma-Al₂O₃ and theta-Al₂O₃ mentioned above actually existed as such a random solid solution form of alumina and La₂O₃. Another one is an ordered form, a distinguished new crystallite phase formulated as LnAl₁₂O₁₉, which was found a significant amount in promoted support Example PS (20 wt % based on the sample weight) and catalyst Example C (18 wt % based on the sample weight), much more than support Example S (7 wt % based on the sample weight). This may suggest that addition of more rare earth element such as samarium might help form more solid solution of LnAl₁₂O₁₉.

Catalyst composition, metal surface area, and metal dispersion are summarized in the Table 2 below for Example C (4%Rh-4%Sm/La₂O₃—Al₂O₃).

TABLE 2
Catalyst Compositions for Example C, metal surface area,
and rhodium dispersion.

| | Active metal | | Metal | |
|---|---|---|---|---|
| | loading, | Promoter | Surface Area, - | Metal dispersion - |
| EX. | wt % | loading, wt % | m²/g rhodium | rhodium, % |
| C | 4% Rh | 4% Sm | 0.53 | 3.0 |

The metal surface area of the catalyst is determined by measuring the dissociative chemical adsorption of H₂ on the surface of the metal. A Micromeritics ASAP 2010 automatic analyzer system is used, employing H₂ as a probe molecule. The ASAP 2010 system uses a flowing gas technique for sample preparation to ensure complete reduction of reducible oxides on the surface of the sample. A gas such as hydrogen flows through the heated sample bed, reducing the oxides on the sample (such as platinum oxide) to the active metal (pure platinum). Since only the active metal phase responds to the chemisorbate (hydrogen in the present case), it is possible to measure the active surface area and metal dispersion independently of the substrate or inactive components. The analyzer uses the static volumetric technique to attain precise dosing of the chemisorbate and rigorously equilibrates the sample. The first analysis measures both strong and weak sorption data in combination. A repeat analysis measures only the weak (reversible) uptake of the probe molecule by the sample supports and the active metal. As many as 1,000 data points can be collected with each point being fully equilibrated. Prior to the measurement of the metal surface area, the sample is pre-treated. The first step is to pretreat the sample in He for 1 hr at 100° C. The sample is then heated to 350° C. in He for 1 hr. These steps clean the surface prior to measurement. Next, the sample is evacuated to sub-atmospheric pressure to remove all previously adsorbed or chemisorbed species. The sample is then oxidized in a 10% oxygen/helium gas at 350° C. for 30 minutes to remove any possible organics that are on the surface. The sample is then reduced at 400° C. for 3 hours in pure hydrogen gas. This reduces any reducible metal oxide to the active metal phase. The sample is then evacuated using a vacuum pump at 400° C. for 2 hours. The sample is then cooled to 35° C. prior to the measurement. The sample is then ready for measurement of the metal surface. From the measurement of the volume of H₂ uptake during the measurement step, it is possible to determine the metal surface area per gram of catalyst structure by the following equation.
MSA=(V)(A)(S)(a)/22400/m

where MSA is the metal surface are in m² /gram of catalyst structure;

V is the volume of adsorbed gas at Standard Temperature and Pressure in ml.;

A is the Avogadro constant;

S is the stoichiometric factor (2 for H₂ chemisorption on rhodium);

m is the sample weight in grams; and

a is the metal cross sectional area.

A temperature-programmed reduction (TPR) was also performed for catalyst Example 3. TPR was used to analyze the metal oxide reducibility and metal-to-support interactions. A 0.05-g sample was pretreated with flowing Argon at temperature of 200° C. for 0.5 hour and cooled down to ambient, then heated up to 800° C. in flowing 20% of H₂/Ar (50 cc/min) at the ramp rate of 10° C./min. The number of reduction peaks can be used to determine the number of environments where metals reside and the temperatures can be used as indicators for metal-to-support interactions, higher temperature stronger metal-to-support interaction. The TPR profile, its peak temperatures and total H₂ consumption, of as-calcined Example C are shown in FIG. 1. Example C had three reduction peaks at temperatures of 122° C., 156° C. and 200° C., respectively, with total H₂ consumption of 9.2 ml/g. The three peaks in the TPR of Example most likely indicated that the support calcined at 1,200° C. resulted in three different kinds of support environments for rhodium to exist, which probably mean that the metal-to-support interactions are non-uniform across the catalyst surface. The lower reduction peak temperature of Example 3 indicates a weaker Rh—O bond on the surface of the catalyst, thereby most likely increasing the amount of metallic rhodium on the surface of the reaction and favoring the direct oxidation mechanism (Scheme 2) as discussed earlier.

### Fixed Bed Reactivity Testing

The catalyst Example C was tested with molecular oxygen and natural gas as the hydrocarbon feed. The natural gas had a typical composition of about 93.1% methane, 3.7% ethane, 1.34% propane, 0.25% butane, 0.007% pentane, 0.01% C₅₊, 0.31% carbon dioxide, 1.26% nitrogen (with % meaning volume percent). The hydrocarbon feed was pre-heated at 300° C. and then mixed with O₂. The reactants were fed into a fixed bed reactor at a carbon to O₂ molar ratio of 1.87 or a O₂:natural gas mass ratio of 1.05 at gas weight hourly space velocities (GHSV) of about 675,000 hr¹. The gas hourly space velocity is defined by the volume of reactant feed per volume of catalyst per hour. The partial oxidation reaction was carried out in a conventional flow apparatus using a 12.7 mm I.D. quartz insert embedded inside a refractory-lined steel vessel. The quartz insert contained a catalyst bed (comprising of 2.0 g of catalyst particles) held between two inert 80-ppi alumina foams. The reaction took place for several days at a pressure of about 90 psig (722 kPa) and at temperatures at the exit of reactor between about 930° C. and about 1010° C. All the flows were controlled by mass flow controllers. The reactor effluent as well as feedstock was analyzed using a gas chromatograph equipped with a thermal conductivity detector. Pressures at the inlet and outlet on the reactor were measured by a differential pressure transmitter, which gives the overall pressure drop across the catalytic bed by subtracting the pressure at the outlet from the pressure at the inlet.

The data analyzed include catalyst performance as determined by conversion and selectivity, and deactivation rate measured for some over a period of over 300 hours. The catalyst performances (CH₄ conversion, H₂ and CO selectivity) at 2 hours after reaction ignition are listed in the following Table 3, and the observed deactivation rate are listed in Table 4.

TABLE 3
Test data for Catalyst Example C with initial CH₄ conversion,
CO and H₂ selectivity at about 24 hours of reaction.

| Catalyst | GHSV, | CH₄ | CO | H₂ |
|---|---|---|---|---|
| Example | hr⁻¹ | conversion, % | selectivity, % | selectivity, % |
| C | 675,000 | 94 | 96 | 96 |

TABLE 4
Deactivation for Catalyst Example C measured over a time period
for about 300⁺ hours at a GHSV of about 675,000 hr⁻¹.

| | | CH₄ | CO | H₂ |
|---|---|---|---|---|
| Catalyst | TOS, | conv. loss, | sel. loss, | sel. loss, |
| Example | hrs | %/day | %/day | %/day |
| C | 321 | 0.48 | 0.14 | 0.48 |

As shown in Table 3, Example C had very good overall catalytic performance towards synthesis gas production. The oxygen conversion (not shown) was also measured for all tests, and was above 99%. As seen in Table 4, Example C appears to deactivate at a slow rate, showing remarkable stability in conversion and selectivity over time.

FIG. 4 shows the plots of the methane conversion and product (H₂ and CO) selectivity for the test run of catalyst Example C, demonstrating the great stability in partial oxidation of natural gas, with only 0.48% loss per day in methane conversion and 0.48% loss per day in hydrogen selectivity for the duration of the run (about 300 hours).

Another preferred embodiment of the present invention comprises a syngas catalyst comprising a high temperature stable support comprising a rare earth-rich aluminate (e.g., of perovskite structure) and a rare earth-lean aluminate (e.g., of hexaaluminate structure), wherein the support may optionally contain low levels, if any, of any alumina phase, e.g., alpha, gamma and theta. The combined alpha phases will comprise less than or equal to about 20 wt % of the total catalyst support. In some preferred embodiments, the combined alumina phases will comprise less than or equal to about 25 wt % of the support weight , preferably less than or equal to about 10 wt %, more preferably less than or equal to about 6 wt %, still preferred less than or equal to about 4 wt %, others less than or equal to about 1 wt %. In some alternate embodiments, the support is essentially free of any alumina phase. In an embodiment, the support comprises a rare earth-rich aluminate with a molar ratio of aluminum to rare earth metal less than 5:1, and a rare earth-lean aluminate with a molar ratio of aluminum to rare earth metal greater than 5:1.

The considerations for other embodiments described herein apply equally to this embodiment. For example, the rare earth-rich aluminate and the rare earth-lean aluminate must contain at least one rare earth metal. Preferably, these rare earth aluminates of differing rare earth contents have at least one rare earth metal in common. In preferred embodiments, the rare earth-rich aluminate comprises a perovskite structure, and the rare earth-lean aluminate comprises a hexaaluminate structure. However, other aluminates are within the scope the embodiment as described herein. Rare earth metals suitable for a perovskite structure include one or more of the lanthanide metals of atomic number between 57 and 68; preferably lanthanum, neodymium, praseodymium, cerium, samarium, and combinations thereof, preferably lanthanum. Rare earth metals suitable for a hexaaluminate structure include any of the lanthanide metals with atomic number between 57 and 60; preferably lanthanum, neodymium, praseodymium, cerium, and combinations thereof, more preferably lanthanum. It is to be understood that the hexaaluminate structure may contain one or more lanthanide metals with atomic number between 57 and 60; or may contain one lanthanide metal with atomic number between 57 and 60 and a rare earth metal with an atomic number outside the 57 to 60 range, such as an hexaaluminate structure comprising both La and Sm (of atomic number of 62); or La and Y(of atomic number of 39; or La and Yb (of atomic number of 70). In preferred embodiments, the rare earth-lean aluminate comprises a lanthanum hexaaluminate. In alternate embodiments, the rare earth-lean aluminate comprises a cation substituted lanthanum hexaaluminate, wherein the lanthanum hexaaluminate further comprises another cation (other than La cation). In preferred embodiments, the rare earth-rich aluminate comprises a lanthanum aluminate perovskite. In alternate embodiments, the rare earth-rich aluminate perovskite comprises a cation-substituted lanthanum aluminate perovskite, wherein the lanthanum aluminate perovskite further comprises another cation (other than La cation). Examples of suitable substitution cations include an additional rare earth metal such as yttrium, cerium, neodymium, praseodymium, samarium, ytterbium, and any combinations of two or more thereof; an alkali metal such as Li; an alkali earth metal such as Mg, Ca, Sr, Ba; or a transition metal. In an embodiment, the catalyst comprises between about 50 wt % and about 90 wt % of the rare earth-lean aluminate of a hexaaluminate structure based on the total weight of the catalyst, alternatively between about 65 wt % and about 90 wt %.

The amount of rare earth aluminate present in the preferred embodiments comprises greater than or equal to about 50 wt % up to less than or equal to about 96 wt % based on the total weight of the catalyst, more preferably greater than or equal to about 60 wt % up to less than or equal to about 96 wt %, and still more preferably greater than or equal to about 65 wt % up to less than or equal to about 90 wt %. The rare earth perovskite comprises less than or equal to about 20 wt % based on the total weight of the catalyst, preferably between about 0.5 wt % and about 20 wt %, and more preferably a range of about 2-15 wt % based on the total weight of the catalyst. All ranges disclosed herein are inclusive and combinable (e.g., ranges of “up to about 96 weight percent (wt. %), with about 60 wt. % to about 96 wt. % desired, and about 65 wt. % to about 90 wt. % more desired,” are inclusive of the endpoints and all intermediate values of the ranges, e.g., “about 50 wt. % to about 90 wt. %, about 65 wt. % to about 96 wt. %”, etc.). IN one embodiment, the catalyst comprises less than 25 wt % alpha-alumina. In an alternative embodiment, the catalyst comprises less than about 15 wt % alumina.

The support may be used to prepare a high temperature stable catalyst (e.g, syngas catalyst). Catalyst considerations are described above and are equally applicable to the present embodiment. For example, a catalyst using the support described immediately above should include one active ingredients which may contain one or more active metals and optionally promoters. Suitable active metals preferably include rhodium, iridium, platinum, palladium, ruthenium, oxides thereof, or combinations thereof; alternatively rhodium, iridium, ruthenium, oxides therof, or combinations thereof; alternatively metallic rhodium, rhodium oxides, or combinations thereof. Such catalysts exhibit CO and hydrogen selectivities and hydrocarbon conversion greater than or equal to about 85%; preferably greater than or equal to about 90% after 300 hours on line under conditions suitable for catalytic partial oxidation of a light hydrocarbon (e.g., any C₁-C₅ alkane like methane, or any combinations thereof, such as ethane and methane combinations, and natural gas). In addition, these catalysts exhibit after stabilization a daily deactivation rate of less than or equal to about a 1%/day in hydrocarbon conversion or in either CO and hydrogen selectivities, and more preferably equal to or less than about 0.5%/day in hydrocarbon conversion or in either CO and hydrogen selectivities over the first 10 days of use under conditions suitable for catalytic partial oxidation (e.g., at super atmospheric pressure greater than 200 kPa). One of ordinary skill in the art will appreciate that the start-up of a catalytic partial oxidation typically take a few hours to a few days of operation until the catalytic partial oxidation conditions (i.e., hydrocarbon feed pressure; hydrocarbon feed preheat; reactant flow rate; etc) have reached their target values. Hence, the first 10 days of use typically exclude the time of reactor start-up, in which the catalytic partial oxidation conditions are transient until they reach their operation targets.

In a more preferred embodiment, the rare earth-rich aluminate (preferably of a perovskite structure) is predominantly located near the surface of the catalyst particle, e.g., in an outer layer. The surface or outer layer containing the rare earth-rich aluminate preferably covers an inner core of the catalyst particle which comprises the rare earth-lean aluminate. It will be appreciated that although it is preferred to completely cover the rare earth-lean aluminate with the rare earth-rich aluminate layer (such as a perovskite layer), certain imperfections in the layer may exist. Nonetheless, the perovskite layer should essentially mask the other aluminate presence near the surface. Preferably, the rare earth-rich aluminate is located in the outer about 10%, more preferably the outer about 6%, and still more preferably the outer about 4% of the catalyst particle as measured from the outer surface radiating inward to the center of the particle. The term ‘particle’ here is meant to cover any suitable divided or discrete structure (i.e., non-monolithic structure). Suitable discrete structures include granules, beads, pills, pastilles, pellets, cylinders, trilobes, extrudates, spheres or other rounded shapes.

Accordingly, a preferred embodiment comprises a high temperature catalyst comprising an active ingredient which is supported by a support, wherein the support comprises an outer layer comprising a rare earth aluminate perovskite, and an inner core comprising a rare earth hexaaluminate phase and optionally an alumina phase, wherein the outer layer is essentially free of any alumina phase. Another embodiment includes the rare-earth aluminate predominately located in an outer layer covering an inner core comprising the rare earth-lean aluminate. Preferably, the outer layer comprises the outer about 10%, more preferably the outer about 6%, and still more preferably the outer about 4% of the catalyst particle as measured from the outer surface radiating inward to the center of the particle (e.g., discrete structure). The active ingredient preferably comprises rhenium or a noble metal of Groups 8, 9, and 10 of the Periodic Table, such as rhodium, iridium, platinum, palladium, ruthenium, oxides thereof, or combinations thereof; more preferably a noble metal selected from the group consisting of rhodium, iridium, ruthenium, oxides thereof, and any combination of two or more thereof, such as alloys comprising at least two of said metals. The compositional considerations for the perovskite, hexaaluminate and active ingredient (e.g., catalytic metal and optionally promoter) are unchanged and may incorporate any of the considerations described herein. One preferred consideration to this embodiment is that the active ingredient or active metal (preferably comprising rhodium) be located within the outer layer and the inner core of the support material. One alternate embodiment is that a majority of the applied active ingredient or active metal (preferably comprising rhodium) be located within the outer layer or on the outer surface of the outer layer of the support discrete structures.

These novel rhodium-containing catalysts supported on discrete structures comprising two types of rare earth aluminates of differing rare earth contents can maintain high hydrocarbon conversion as well as high CO and H₂ selectivities (i.e., all higher than 85%) during partial oxidation of said hydrocarbon with O₂ at a pressure of 200 kPa or more; preferably of about 700 kPa or more; more preferably between about 700 kPa and about 3600 kPa; most preferably between about 700 kPa and about 2000 kPa. Excellent performance can be obtained between about 200 kPa and about 1600 kPa. For example, for methane partial oxidation in the presence of these catalysts at a pressure greater than about 700 kPa, methane conversion as well as hydrogen and carbon monoxide selectivities can be maintained at values greater than 85% over extended periods of time (10 days or more; preferably 30 days or morel more preferably 60 days or more) with little to no deactivation of the syngas catalyst. Additionally, the selectivity towards carbon dioxide (CO₂) is low, preferably less than 8%, more preferably less than 5%. Moreover, the selectivity towards hydrocarbonaceous compounds with a number of carbons greater than that of the hydrocarbon feed (such as C₂₊ for a methane hydrocarbon feed) is low, preferably less than about 1%, more preferably less than about 0.5%. The deactivation rate of these catalysts is very low and it is expected that the daily deactivation rate in hydrocarbon conversion, or in CO selectivity, or in hydrogen selectivity (i.e., decrease in values over a certain time period) is 1%/day or less over the first 10 days of use (excluding the start-up period); preferably 0.75%/day or less; more preferably 0.5%/day or less. In large-scale operation using a methane-containing gas (e.g., between 80% and 100% methane, such as natural gas) and essentially pure oxygen over kilogram quantities of these novel catalysts, the deactivation rate of these catalysts can be 0.1%/day or less; or even 0.05%/day or less for all three hydrocarbon conversion, CO selectivity, and hydrogen selectivity over a period of operation of 10 days or more (excluding the start-up period).

### EXAMPLES

To improve the catalyst thermal stability, four catalysts Examples C1, C2, C3 and C4 were made without La (Examples C3 and C4) or with high loading of La (Examples C1 and C2) by calcining a gamma-alumina material at a high temperature of about 1,400° C.

### Support Example S1 with High La Loading

Support preparation for catalyst Examples C1 and C2: An aluminum-containing precursor was obtained as gamma-Al₂O₃ spheres (#2750) from Davison with the following characteristics: a size in the range of 1.2 to 1.4 mm (average diameter of 1.3 mm.), a bulk density of 0.44 g/ml, a surface area and pore volume measure with N₂ adsorption of 143 m²/g and 0.75 ml/g respectively. For generating lanthanum-modified supports with a high lanthanum loading, Al₂O₃ spheres were impregnated with a lanthanum nitrate (La(NO₃)₃) solution, dried in an oven at 120° C. overnight, and then calcined in air with a temperature ramp of 1.5° C./min until reaching a calcination temperature of about 1,400° C. and held there for 3 hours. The γ-Al₂O₃ spheres were impregnated with an aqueous solution containing desired amount of La(NO₃)₃ so that, after drying and calcination, the lanthanum oxide (La₂O₃) amount in the final material was approximately 25 wt % by weight of the total support (this corresponds to a weight content of about 21.3 wt % La). This provided the catalyst support Example S1.

For the catalyst support modified with high-lanthanum loading (Example S1), the calcination at 1,400° C. resulted in a mixture of alpha-Al₂O₃ (about 4-6 wt %), lanthanum hexaaluminate (about 72-76 wt %), and lanthanum perovskite (about 10 wt %).

### Example C1

### 4%Rh/25%La₂O₃—Al₂O₃

Catalyst preparation: The catalyst was prepared by the impregnation of Rh(NO₃)₃ solutions on the La₂O₃-modified Al₂O₃ support material obtained above (Example S1) to form a catalyst precursor, which was dried at 120° C. overnight and then calcined at 450° C. in air for 3 hours (the calcinations temperature was ramped at 1.5° C./min). The calcined sample was reduced in 20% H₂/He with a temperature ramping rate of 1° C./min to 400° C. and the temperature was held at 400° C. for 3 hours. The reduced catalyst was again heat-treated (second calcination) with a temperature ramping rate of 2.5° C./min in flowing helium at about 1400° C. and held at this temperature for 3 hours (this step is called “post-reduction treatment”). The catalyst was then ready to be loaded into the reactor for testing. The Rh metal content in the catalyst was 4% by weight determined by mass balance.

### Example C2

### 2% Rh/25%La₂O₃—Al₂O₃

The catalyst preparation procedure is similar to that of Example C1, except the amount of Rh(NO₃)₃ in the impregnating solution is such that the Rh content in the final catalyst was 2 wt % Rh instead of the loading of 4 wt % Rh in Example C1.

Table 5 lists the alumina phase content, the rare earth aluminate content (hexaaluminate-type), the lanthanum oxide (La₂O₃) content, BET surface areas, pore volume, total pore volume and average pore diameter. BET surface areas, pore volume, total pore volume and average pore diameter were measured by the BJH desorption method using N₂ as the adsorptive of the modified alumina catalyst support, and the fresh catalysts made therefrom. The phase composition of the catalyst examples was done by Rietveld X-Ray Diffraction as described earlier.

### Support Example S2 Without La Loading

Support preparation for Examples C3 and C4: the gamma-Al₂O₃ spheres from Davison as used for support Example S1 was calcined in air at a calcination temperature of about 1,400° C. for 3 hours. For the unmodified catalyst support with no lanthanum addition (Example E), the calcination at 1,400° C. resulted in essentially conversion of the gamma-alumina into alpha-Al₂O₃.

### Example C3

### 4% Rh/alpha-Al₂O₃

The catalyst preparation procedure is similar to that of Example C1 except the Rh(NO₃)₃ containing impregnating solution was applied to the support Example S2 (without modification with La). The Rh content in the final catalyst was 4 wt %.

### Example C4

### 2% Rh/alpha-Al₂O₃

The catalyst preparation procedure is similar to that Example C3, except the amount of Rh(NO₃)₃ in the impregnating solution is such that the Rh content in the final catalyst was 2 wt % Rh instead of the loading of 4 wt % Rh in Example C3.

### Analysis of Examples C1, C2, C3 and C4

As expected, the supports for Examples C3 and C4 that were made without La modification consisting essentially of alpha alumina, while Examples C1 and C2 that were supported on 25% La modified alumina had a very low alpha-alumina content (6% and 4%, respectively). The majority of the phases in catalyst Examples C1 and C2 was lanthanum hexaaluminate whose content was around 72-76 wt %.

The addition of rhodium in Examples C1 and C2 and subsequent calcination at 450° C., reduction at 400° C. and post-reduction treatment at 1,400° C. in an inert environment (e.g., helium) providing a composition consisting essentially of rhodium (about 4 wt %), alpha-Al₂O₃ (about 4-6 wt %), lanthanum hexaaluminate (about 72-76 wt %), and lanthanum aluminate perovskite (about 10 wt %). Based on a Transmission Electron Microscope (TEM) examination, this lanthanum hexaaluminate phase coexisted with a small fraction of alpha-alumina and appeared to exist in a unique thin platelet morphology with thickness of about 20 nm. Therefore Examples EXAMPLE C1 and C2 had similar composition of the various phases. From Table 5, it is noted that after the series of steps: calcination/reduction/post-treatment in the presence of a lanthanum precursor compound, the deposited (e.g., impregnated) lanthanum atoms were incorporated into two lanthanum aluminate phases (hexaaluminate and perovskite) and, in some cases, in a very rich La-containing phase (most likely lanthanum oxide). On the other end, the aluminum atoms from gamma-Al₂O₃ incorporated into the lanthanum aluminates and a small amount in a denser alumina phase (alpha-alumina).

TABLE 5
formulation, catalyst BET surface area, total pore volume, average pore diameter, and support
phase distribution based on results of XRD Rietveld refinement for Fresh catalyst Examples

| | | | | | | | Estimated content of | | |
|---|---|---|---|---|---|---|---|---|---|
| | | BET SA, | Total Pore | Avg. Pore | LaAlO₃^{e} | LaAl_{y}O_{z}^{f} | alumina phases^{d} (wt %) | | |
| EX. | Composition | m²/g | Vol. ml/g | Size, nm | (wt %) | (wt %) | γ | θ | α |
| C3 | 4% Rh/ | 3.2 | 0.02 | 20 | 0 | 0 | 0 | 0 | 100 |
| catalyst^{a} | Al₂O₃ | | | | | | | | |
| C4 | 2% Rh/ | 3.2 | 0.02 | 19 | 0 | 0 | 0 | 0 | 100 |
| catalyst^{b} | Al₂O₃ | | | | | | | | |
| C1 | 4% Rh/ | 4.6 | 0.05 | 33 | 10 | 72 | 0 | 12 | 6 |
| catalyst^{a} | 25% La₂O₃—Al₂O₃ | | | | | | | | |
| C2 | 2% Rh/ | 4.6 | 0.04 | 28 | 10 | 76 | 0 | 10 | 4 |
| catalyst^{b} | 25% La₂O₃—Al₂O₃ | | | | | | | | |

^{a}this sample also contained 4% rhodium as measured by XRD Rietveld refinement
^{b}this sample also contained 2% rhodium as measured by XRD Rietveld refinement
^{c}this sample also contained 5% rhodium as measured by XRD Rietveld refinement
^{d}γ, θ, and α refer to gamma-alumina phase, theta-alumina phase and alpha-alumina phase, respectively
^{e}LaAlO₃ represents a lanthanum aluminate of a perovskite or spinel structure
^{f}LaAl_{y}O_{z} represents a lanthanum hexaaluminate-like structure with y = 11-12 and z = 18-19.

It has been further observed that the conditions of the post-reduction treatment at 1,400° C. in an inert environment (e.g., helium) can be adjusted to further provide the complete removal of the alpha-alumina phase in the catalyst, so that the aluminum atoms from the aluminum-containing precursor compound (e.g., gamma-Al₂O₃) are incorporated into the lanthanum aluminates so that the catalyst composition does not contain any alumina phase (i.e., the alumina precursor is completely converted to lanthanum aluminates of different crystalline structures). Adjustments to the conditions of the post-reduction treatment may include increasing the holding time while the composition is subjected to the post-reduction treatment temperature (e.g., 1,400° C.); and/or adjusting the O₂ content of the post-reduction treatment to be as low as possible (i.e., below 100 ppm O₂; preferably less than 10 ppm O₂) by a displacement method (in which the O₂ content in the environment is slowly decreased by flowing an inert gas or inert gas mixtures) and/or by an evacuation method (in which the environment is first evacuated and then replaced with an inert gas or inert gas mixtures).

### Reactor Testing at 90 psig of Examples C1, C2, C3 and C4

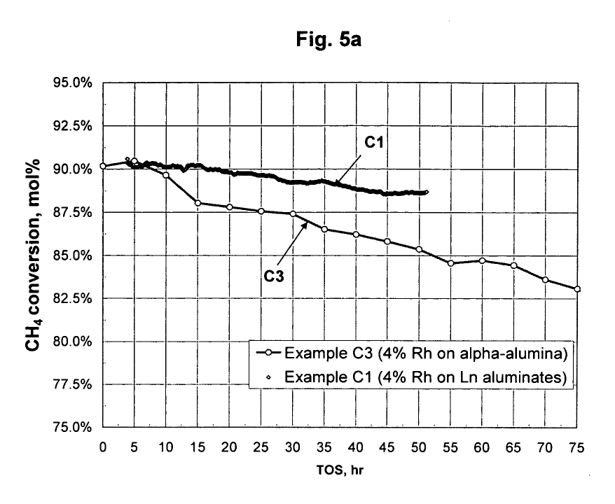

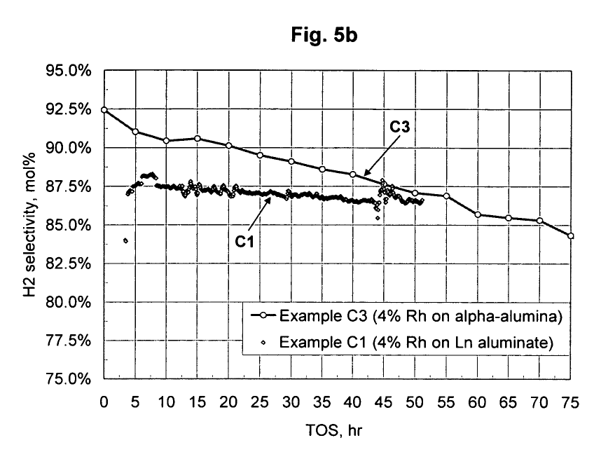

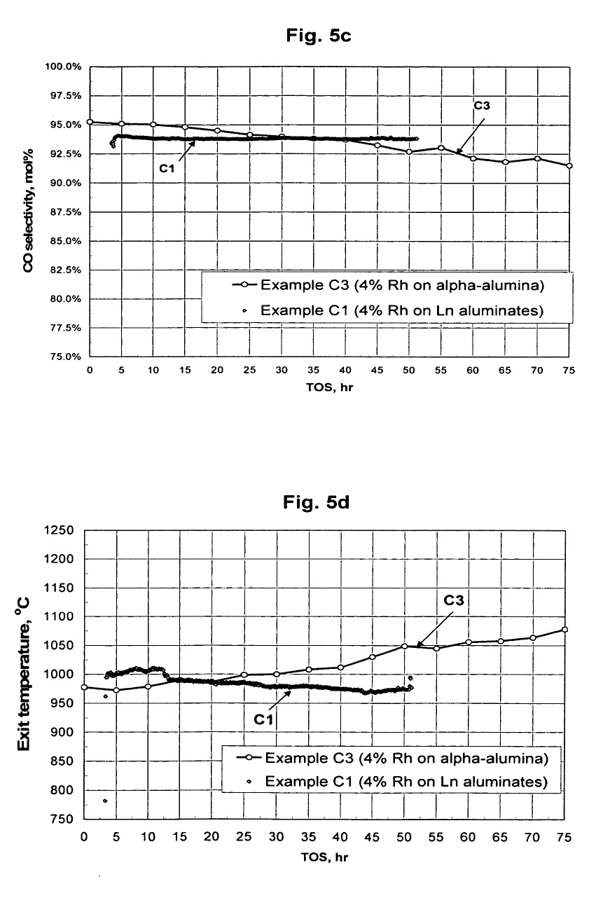

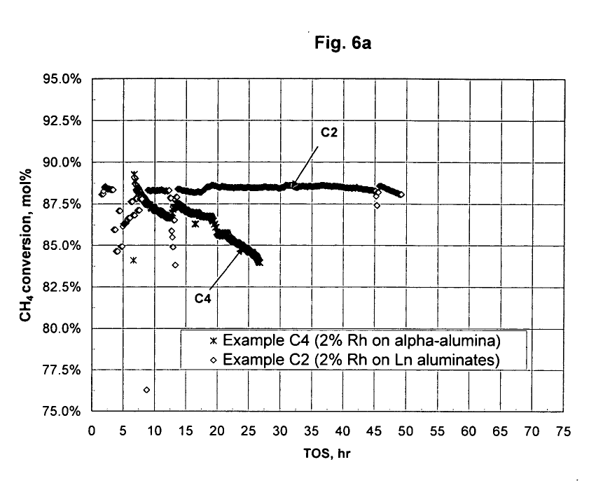

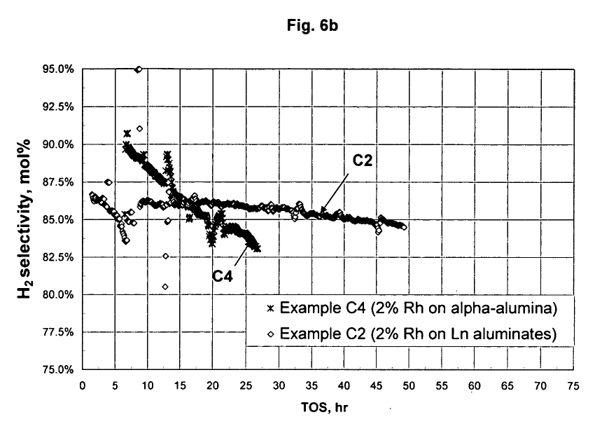

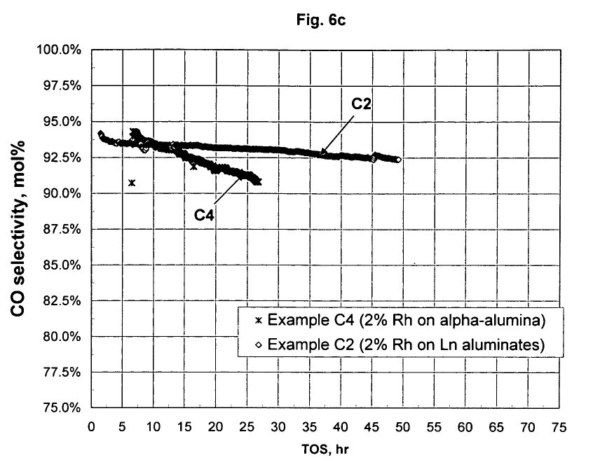

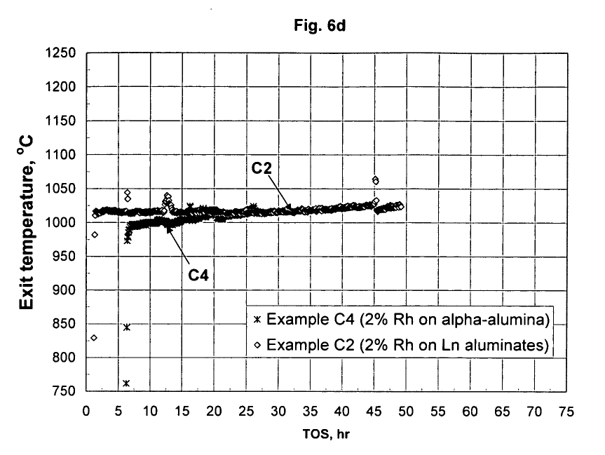

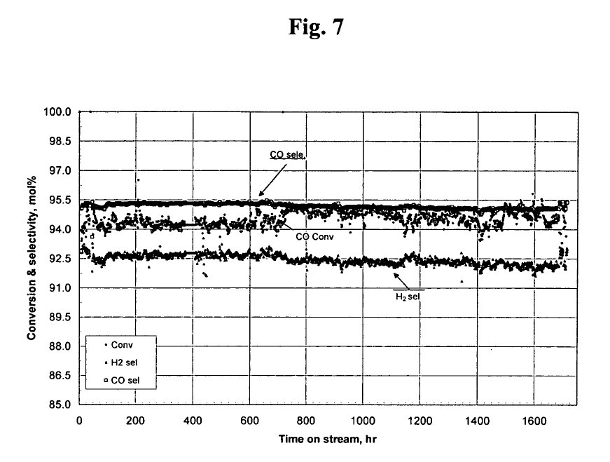

Examples C1, C2, C3 and C4 were tested in a fixed-bed reactor at 90 psig (about 720 kPa) with a GHSV of about 800,000 hr⁻¹ or a WHSV of about 940 hr5⁻¹ using the same procedure as Example C. The reactant gas comprised 02 and natural gas (containing 90-92% methane, 4.7-5.7% ethane, the remainder including C₃₊ alkanes, ca. 1% nitrogen and ca. 0.25-0.3% CO₂) at a O₂:methane weight ratio of about 1.05 (or O₂:C molar ratio of about 0.57-0.58). The performance results are illustrated in FIGS. 5a-5d for Ex. C1 and C3 (4% Rh catalysts) and 6a-6d for Ex. C2 and C4 (2% Rh catalysts). FIGS. 5a-5d compared the performance of the 4% Rh-containing catalysts (5a: methane conversion versus time on stream; 5b: H₂ selectivity; 5c: CO selectivity; 5d: exit temperature), whereas FIGS. 6a-6d compared the performance of the 2% Rh-containing catalysts (6a: methane conversion versus time on stream; 6b: H₂ selectivity; 6c: CO selectivity; 6d: exit temperature). Table 6 lists the initial performance of the catalyst examples C1-C4 at about 5-10 hours after start-up; and Table 7 lists the deactivation rate calculated from this initial performance to about 45-50 hours of operation.

As shown in FIGS. 5a-5b, in a 45-hr period (from 5 to 50 hours), the methane conversion, H₂ selectivity and CO selectivity for Example C3 (4% Rh on alpha-alumina) decreased from about 90.5% to about 85.3%; from about 91.1 to about 87.3%; and from about 95.1 to about 92.6%, respectively, whereas in a 45-hr period (from 5 to 50 hours), the methane conversion, H₂ selectivity and CO selectivity for Example C1 (4% Rh on La aluminates) decreased from about 90 to about 88.8%; from about 87.5 to about 86.7%; and from about 94.0 to about 93.8%, respectively.

Similarly, as shown in FIGS. 6a-6b, in a 15-hr period (from 10 to 25 hours), the methane conversion, H₂ selectivity and CO selectivity for Example C4 (2% Rh on alpha-alumina) decreased from about 87.0 to about 84.8%; from about 88.8 to about 83.8%; and from about 93.4 to about 91.2%, respectively, whereas in a 35-hr period (from 10 to 45 hours), the CO conversion, H₂ selectivity and CO selectivity for Example C2 (2% Rh on La aluminates) varied from about 88.3 to about 88.35%; from about 86.3 to about 85.0%; and from about 93.4 to about 92.5%, respectively.

TABLE 6
Test data for Catalyst Examples C1-C4 with initial CH₄
conversion, CO and H₂ selectivity at about 5 hours of reaction
at a GHSV of about 800,000 hr⁻¹ or WHSV of about 940 hr⁻¹.

| | | | | H₂ |
|---|---|---|---|---|
| Catalyst | Catalyst | CH₄ | CO | selectivity, |
| Example | composition | conversion, % | selectivity, % | % |
| C1 | 4% Rh | 90.0 | 94.0 | 87.5 |
| | on La | | | |
| | aluminates | | | |
| C2 | 2% Rh | 88.3 | 93.4 | 86.3 |
| | on La | | | |
| | aluminates | | | |
| C3 | 4% Rh | 90.5 | 95.1 | 91.1 |
| | on α-Al₂O₃ | | | |
| C4 | 2% Rh | 87.0 | 93.4 | 88.8 |
| | on α-Al₂O₃ | | | |

TABLE 7
Deactivation for Catalyst Examples C1-C4 measured over a time period
at a pressure of about 90 psig and a GHSV of about 800,000 hr⁻¹.

| | Catalyst | Time period for | Deactivation Rate* | Deactivation Rate* | Deactivation Rate* |
|---|---|---|---|---|---|
| EX | composition | deactivation, hrs | In CH₄ conv., %/day | In CO sel., %/day | In H₂ sel., %/day |
| C1 | 4% Rh | 45 | 0.75 | 0.13 | 0.43 |
| | on La aluminates | | | | |
| C2 | 2% Rh | 35 | −0.03 | 0.62 | 0.86 |
| | on La aluminates | | | | |
| C3 | 4% Rh | 45 | 2.8 | 1.33 | 2.03 |
| | on α-Al₂O₃ | | | | |
| C4 | 2% Rh | 15 | 3.6 | 3.52 | 8.0 |
| | on α-Al₂O₃ | | | | |

*a negative value indicates an increase in performance, whereas a positive number indicates deactivation.

In correlation with the reactor performance, the catalysts supported on essentially alpha alumina (Examples C3 and C4) demonstrated much higher deactivation rate than those supported on La aluminates by modification of alumina with a high La loading (Examples C1 and C2). As shown in FIGS. 5b and 6b, the Rh catalysts on alpha-alumina (Examples C3 and C4) had approximately 6 to 9% daily decay rate in H₂ selectivity whereas the Rh catalysts on La aluminates (Examples C1 and C2) had about 1% or less daily deactivation rate.

Furthermore, as shown in FIGS. 5d and 6d, the exit temperature of the catalyst bed loaded with either catalyst Examples C3 and C4 (with no added La on the support) increased over time (for example, the 4% Rh catalyst Example C3 had a ca. 100° C. increase in exit temperature during the 75-hr period; and the 2% Rh catalyst Example C4 had ca. 60° C. increase in exit temperature during the 20-hr period). To the contrary, the exit temperature of the bed loaded with either Examples C1 and C2 was more stable over time (for example, the 4% Rh Example C1 catalyst has a ca. 40° C. decrease in exit temperature and the 2% Rh Example C2 catalyst only had a small increase of ca. 10° C. in exit temperature both during a 45-hr period). It is to be noted that the exit temperature for the catalyst bed containing the lower 2% Rh loading (Example C2) was between about 1,010° C. and about 1,020+ C. and was a little higher than that obtained for the catalyst bed containing the higher 4% Rh loading (Example C1) between about 1,005° C. and about 965° C.

For a long-term operation of a commercial scale reactor for the partial oxidation of methane or natural gas, it is desirable to maintain the exit temperature of the catalytic bed within a desired range (e.g., about 800-1,100° C. or about 850-1,050° C.), as too high gas phase temperature in the catalyst bed may cause further deactivation of the catalyst. In preferred embodiments, the exit temperature of the catalytic bed should not exceed 1,100° C. A change to the exit temperature should be less than 30° C. per day of time on stream; preferably less than 25° C. per day; more preferably less than 21° C. per day; or in some embodiments, less than 10° C. per day, preferably less than about 5° C. per day, more preferably less than about 2° C. per day over the course of the first 2 to 10 days.

### Example C5

Example C5 was made with gamma-alumina spheres as starting material for the supported catalyst using the same procedure as described for Example C1. The catalyst phase distribution is listed in Table 8.

### Reactor Testing of Example C5 at 150 psig

Example C5 (9.5 g) was tested in a fixed-bed 1-inch diameter reactor at 150 psig (about kPa) in Run 1 at a WHSV of 1320 hr⁻¹ (or a GHSV of 1,110,000 hr⁻¹) and Run 2 at a WHSV of 1208 hr⁻¹ (or a GHSV of 1,004,000 hr⁻¹) using the same procedure as Example C. The performance and deactivation rates are listed in Table 9 for both runs.

TABLE 8
Catalyst phase distribution based on results of XRD Rietveld
refinement for fresh and spent catalyst Example C5

| | | | | | Estimated content of | | |
|---|---|---|---|---|---|---|---|
| | | Rh metal, | LaAlO₃^{e} | LaAl_{y}O_{z}^{f} | alumina phases^{d} (wt %) | | |
| EX. | Composition | (wt %) | (wt %) | (wt %) | γ | θ | α |
| C5 | 4% Rh/ | 14 | 9.7 | 71 | 0 | 0 | 5.3 |
| catalyst^{a} | 25% La₂O₃—Al₂O₃ | | | | | | |
| Spent C5′ | 4% Rh/ | 30 | 6.9 | 57 | 0 | 0 | 24 |
| catalyst^{b} | 25% La₂O₃—Al₂O₃ | | | | | | |

TABLE 9
Test data for Example C5 at about 150 psig

| | | | | Deactivation |
|---|---|---|---|---|
| | | @ 10 hrs | @ 230 hrs | Rate*, |
| | | TOS | TOS | %/day |
| Ex. C5 | CH₄ conv., % | 89 | 82 | 0.76 |
| Run 1 | CO selectivity, % | 95 | 92 | 0.93 |
| | H₂ selectivity, % | 92.5 | 84 | 0.33 |
| | | | | Deactivation |
| | | @ 12 hrs | @ 144 hrs | Rate*, |
| | | TOS | TOS | %/day |
| Ex. C5 | CH₄ conv., % | 91 | 88.5 | 0.45 |
| Run 2 | CO selectivity, % | 95.5 | 94.5 | 0.18 |
| | H₂ selectivity, % | 94 | 91.3 | 0.49 |

*A positive number indicates deactivation.

After more than 14 days of operation in Run 1 at a pressure of at least 150 psig (about 1130 kPa) in a fixed-bed reactor for the partial oxidation of natural gas with O₂ as described above with Ex. C5, a spent catalyst sample C5′ was recovered from the reactor catalytic bed and characterized for phase composition. In the spent catalyst C5′, the La hexaaluminate phase declined to about 57% (from about 72% in the fresh catalyst) and the La aluminate perovskite also decreased to 7% (from about 10% in the fresh catalyst C5), while alpha-alumina phase increased to about 24% (from about 6% in the fresh catalyst C5), and the theta-alumina phase was no longer present (from about 12% in the fresh catalyst C5). Another interesting finding was that La appeared to form La-rich particles (probably lanthanum oxide), which structure has not been defined. Rhodium sintering was also observed in the spent catalyst C5′. While in the fresh catalyst comprising Rh on lanthanum aluminates, the Rh particles were often faceted or spherical, rhodium in the spent catalyst seemed to aggregate in bigger, irregular shaped particles.

### Example C6

### Catalyst Large-Scale Preparation of a 4%-Rh Catalyst

A large batch Example C6 (of about 30 kilograms) of a 4%-Rh catalyst based on a support was prepared by first modifying gamma-alumina trilobes (containing small amounts of silicon resulting from a silica binder) with 25 wt % La₂O₃. The gamma-alumina trilobes contained small amounts of silicon resulting from a silica binder used during extrusion of the trilobes. The gamma-alumina trilobes had a diameter of about 0.1 inch (about 0.25 mm) up to a length of about 0.5 inch (about 1.27 mm). The preparation of the catalyst started by drying the gamma-alumina trilobes at about 120° C. to remove moisture. A lanthanide precursor (La(NO₃)₃.6H₂O) compound was dissolved in water (885.58 g La(NO₃)₃.6H₂O per kilogram of gamma-alumina material), and the solution of lanthanum nitrate was impregnated onto the γ-Al₂O₃ trilobes. The impregnated material was dried in an oven at 120° C. for 6 hours; followed by another heating step with a ramp rate of 1.5° C./min up to about 450° C. and held at that temperature for 3 hours for removal of nitrogen oxides (resulting from nitrate decomposition); and finally calcined at 1,400° C. for 3 hours, with a ramp rate of 1.5° C./min so as to obtain a 25 wt % La-modified support.

Next, a solution of a rhodium precursor compound (Rh(NO₃)₃) was dissolved in water, and the rhodium solution was impregnated onto the 25 wt % La-modified trilobes. The Rh-impregnated material was dried in an oven at 120° C. for 6 hours; then heated with a ramp rate of 1.5° C./min up to about 450° C. and held at that temperature for 3 hours for removal of nitrogen oxides (resulting from nitrate decomposition); and finally calcined at 450° C. in air for 3 hours with a ramp rate of 1.5° C./min to form a calcined catalyst precursor. The calcined catalyst precursor was then reduced under a reducing atmosphere (i.e., 20% H₂ in nitrogen) with a ramp rate of 1° C./min up to 300° C. and held there for 3 hours.

A portion of the reduced catalyst was finally treated in a stationary kiln with flowing helium over the reduced catalyst with a heating ramp rate of 2.5° C./min and held at 1,400° C. for 3 hours to obtain the finished catalyst Example C6.

Based on XRD Rietveld refinement analysis, the catalyst Example C6 contained alpha-alumina (about 18%), lanthanum hexaaluminate (about 66%), lanthanum aluminate perovskite (about 14%), and rhodium (about 1.3%). XRD technique cannot quantify rhodium in an oxide form.

Multiple batches of catalysts using modified and calcined gamma-alumina spheres or trilobes were made using the procedure of Example C6, and the fresh catalyst compositions (determined by XRD Rietveld refinement analysis) were similar to Example C6. They contained alpha-alumina (from about 13% to about 21%) with an average crystallize size varying from 85 nm to 103 nm, lanthanum hexaaluminate (from about 42% to about 76%) with an average crystallize size varying from 22 mn to 30 nm, lanthanum aluminate perovskite (from about 6% to about 16%) with an average crystallize size varying from 7 nm to 23 nm, and rhodium (from about 1.2% to about 2.3%) with an average crystallize size varying from 30 nm to 60 nm. XRD sizing of crystallites was performed using the Scherrer equation (see for example H. P. Klug and L. E. Alexander, X-Ray Diffraction Procedures for Polycrystalline and Amorphous Materials, John Wiley, New York, 2nd Edition, 1974).

### Example C7

### Different Post-Reduction Treatment of Catalyst

In lieu of submitting the reduced catalyst with flowing helium in a stationary kiln as described for Example C6, another portion of the reduced catalyst as obtained above was submitted to a different post-reduction treatment in an air-tight high-temperature furnace. The reduced catalyst sample was placed inside the furnace and the air (containing oxygen) in the air-tight furnace was first evacuated and then replaced with argon so as to essentially completely remove oxygen from the gas phase inside the air-tight high-temperature furnace (the procedure can be repeated until the oxygen content is below a desired level (e.g., less than 1 ppm O₂). After the oxygen displacement, the reduced catalyst sample was heated with a ramp rate of 2.5° C./min up to 1,400° C. and held at that temperature for 3 hours, to obtain the finished catalyst Example C7.

Based on XRD Rietveld refinement analysis, the catalyst Example C7 did not contain an alumina phase, as the aluminum atoms from the original gamma-alumina material were incorporated into about 89% lanthanum hexaaaluminate lean in La (LaAl₁₁O18) and about 6% lanthanum aluminate of a perovskite structure rich in La (LaAlO₃) in the finished catalyst (see Table 10). The data from XRD Rietvield refinement further provided that the lanthanum hexaaluminate had an average crystallite size of about 66 nm; and the lanthanum aluminate of a perovskite structure had an average crystallite size of about 40 nm.

TABLE 10
Catalyst phase distribution based on results of XRD Rietveld refinement for fresh
catalyst Examples C6 and C7 (4% Rh/25% La₂O₃—Al₂O₃)

| | | | | | | | Estimated content of | | |
|---|---|---|---|---|---|---|---|---|---|
| | Post-reduction | BET SA, | Total Pore | Avg. Pore | LaAlO₃^{e} | LaAl_{y}O_{z}^{f} | alumina phases^{d} (wt %) | | |
| EX. | treatment | m²/g | Vol., ml/g | Size, nm | (wt %) | (wt %) | γ | θ | α |
| C6 | Kiln with flowing | 8.9 | 0.04 | 19 | 14 | 66 | 0 | 0 | 18 |
| | helium | | | | | | | | |
| C7 | Furnace with O2 | 1.9 | 0.02 | 47 | 6 | 89 | 0 | 0 | 0 |
| | evatation and argon | | | | | | | | |
| | replacement | | | | | | | | |

^{d}γ, θ, and α refer to gamma-alumina phase, theta-alumina phase and alpha-alumina phase, respectively
^{e}LaAlO₃ represents a lanthanum aluminate of a perovskite structure
^{f}LaAl_{y}O_{z} represents a lanthanum hexaaluminate-like structure with y = 11-12 and z = 18-19.

### Reactor Testing of Example C6 at 180 psig (Large-Scale Reactor)

Example C6 was tested in a large-scale fixed-bed reactor at 180 psig (about 1340 kPa) using a refractory lined steel reactor containing about 10 kg of catalyst. Natural gas was heated at a preheat temperature of about 397° F. (ca. 203° C.) and then mixed with essentially pure O₂ to obtain a reactant gas with an O₂/C molar ratio of about 0.56-0.57. The reactant gas was fed to the catalytic bed at a weight hourly space velocity of about 443 hr⁻¹ (or a gas hourly space velocity of about 380,000 hr⁻¹) over the course of about 67 days. The exit temperature averaged 1,865° F. (ca. 1,018° C.), but increased very slowly over the course of the 67-day operation from about 1,850° F. (ca. 1,010° C.) to about 1,900° F. (ca. 1,038° C.) representing a small exit temperature increase of about 0.75° C. per day. The performance results (methane conversion; H₂ selectivity; CO selectivity) versus time on stream are illustrated in FIG. 8 and listed in Table 11 for 100 and 1600 hours TOS. The average methane conversion, H₂ selectivity, CO selectivity over a 62-day period were about 94.5%, 92.8%, and 95.3%, with a CO₂ selectivity of about 4.8%. The methane conversion slightly increased, whereas the H₂ and CO selectivities slightly decreased. The estimated deactivation rates (listed in Table 11) for a time period between 100 hours and 1600 hours of time on stream (about 62.5 days of use) were −0.003%/day for methane conversion; 0.014%/day for H₂ selectivity; and 0.005%/day for CO selectivity. The resulting H₂:CO ratio of the reactor effluent was about 1.9:1 for the 60⁺ days of operation.

TABLE 11
Performance data for Example C6 at about 180 psig (in large-scale reactor)

| | | | | Deactivation |
|---|---|---|---|---|
| | | @ 100 hrs | @ 1600 hrs | Rate*, |
| | | TOS | TOS | %/day |
| Ex. C6 | CH₄ conv., % | 94.5 | 94.7 | −0.003 |
| Run | CO selectivity, % | 95.3 | 95.0 | 0.005 |
| | H₂ selectivity, % | 92.8 | 91.9 | 0.014 |

### Reactor Testing of Example C7 at 90 psig

Example C7 (2.58 g) was tested in a fixed-bed 0.5-inch diameter reactor at 90 psig (about 720 kPa) at a WHSV of 780 hr⁻¹ (or a GHSV of 800,000 hr⁻¹) using the same procedure as Example C. The performance and deactivation rates are listed in Table 12 for the run. The exit temperature decreased from 940° C. at 24 hrs to 920° C. at 168 hrs on stream to provide a decreasing rate of 3.3° C./day.

TABLE 12
Performance data for Example C7 at about 90 psig

| | | | | Deactivation |
|---|---|---|---|---|
| | | @ 24 hrs | @ 168 hrs | Rate*, |
| | | TOS | TOS | %/day |
| Ex. C7 | CH₄ conv., % | 94 | 92.5 | 0.25 |
| Run | CO selectivity, % | 96.1 | 96.0 | 0.02 |
| | H₂ selectivity, % | 91.5 | 91.0 | 0.08 |

These embodiments are more fully understood by the Examples below.

The examples and testing data show that the catalyst compositions of the present invention represent an improvement over prior art partial oxidation catalysts in their ability to resist deactivation over sustained time periods while maintaining high methane conversion and hydrogen and carbon monoxide selectivity values. While the preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims. The disclosures of all issued patents, patent applications and publications cited herein are incorporated by reference. The discussion of certain references in the Description of Related Art, above, is not an admission that they are prior art to the present invention, especially any references that may have a publication date after the priority date of this application.

1. A high temperature stable syngas catalyst comprising:
an active ingredient comprising a metal selected from the group consisting of rhodium, iridium, platinum, palladium, ruthenium, oxides thereof, and combinations thereof,
said active ingredient being supported on a catalyst support comprising a rare earth-rich aluminate with a molar ratio of aluminum to rare earth metal less than 5:1; and a rare earth-lean aluminate with a molar ratio of aluminum to rare earth metal greater than 5:1,
wherein the support is in the form of discrete structures.

2. The catalyst according to claim 1 wherein the active ingredient comprises a metal selected from the group consisting of rhodium, iridium, ruthenium, oxides thereof, and combinations thereof.

3. The catalyst according to claim 1 wherein the active ingredient comprises metallic rhodium, rhodium oxide, or combination thereof.

4. The catalyst according to claim 3 wherein the catalyst comprises between about 0.5 wt % and about 10 wt % of rhodium.

5. The catalyst according to claim 3 wherein the catalyst comprises between about 0.5 wt % and about 6 wt % of rhodium.

6. The catalyst according to claim 1 wherein the support contains less than 25 wt % of alpha, gamma and theta alumina combined.

7. The catalyst according to claim 1 wherein the support contains less than 10 wt % of alpha, gamma and theta alumina combined.

8. The catalyst according to claim 1 wherein the support comprises less than 6 wt % of alpha, gamma and theta alumina combined.

9. The catalyst according to claim 1 wherein the support is essentially free of alpha, gamma and theta alumina.

10. The catalyst according to claim 1 wherein the support comprises a rare earth content greater than the stoichiometric rare earth content of the corresponding rare earth hexaaluminate structure but lower than the stoichiometric rare earth content of the corresponding rare earth aluminate of perovskite structure, exclusive of said stoichiometric rare earth contents.

11. The catalyst according to claim 1 wherein the rare earth-lean aluminate comprises a hexaaluminate structure.

12. The catalyst according to claim 10 wherein the catalyst comprises between about 50 wt % and about 96 wt % of the rare earth hexaaluminate based on the total weight of the catalyst.

13. The catalyst according to claim 10 wherein the catalyst comprises between about 60 wt % and about 90 wt % of the rare earth hexaaluminate based on the total weight of the catalyst.

14. The catalyst according to claim 1 wherein both rare earth aluminates comprise the same rare earth metal selected from the group consisting of lanthanum, neodymium, praseodymium, cerium, samarium, and combinations thereof.

15. The catalyst according to claim 1 wherein both rare earth aluminates comprise lanthanum.

16. The catalyst according to claim 15 wherein the catalyst comprises between 19.2 wt % and 65 wt % of lanthanum based on the total weight of the catalyst, exclusive of endpoints.

17. The catalyst according to claim 15 wherein the catalyst comprises between 20 wt % and 30 wt % of lanthanum based on the total weight of the catalyst, inclusive of endpoints.

18. The catalyst according to claim 1 wherein the rare earth-rich aluminate comprises a perovskite structure.

19. The catalyst according to claim 18 wherein the catalyst comprises between about 0.5 wt % and about 20 wt % of the rare earth aluminate perovskite based on the total weight of the catalyst.

20. The catalyst according to claim 18 wherein the catalyst comprises between about 2 and about 15 wt % of the rare earth aluminate perovskite based on the total weight of the catalyst.

21. The catalyst according to claim 1 wherein the catalyst comprises between about 50 wt % and about 90 wt % of the rare earth-lean aluminate of a hexaaluminate structure based on the total weight of the catalyst.

22. The catalyst according to claim 1 wherein the catalyst comprises between about 65 wt % and about 90 wt % of the rare earth-lean aluminate of a hexaaluminate structure based on the total weight of the catalyst.

23. The catalyst according to claim 1 wherein the rare earth-rich aluminate comprises a rare earth metal selected from the group consisting of lanthanum, neodymium, praseodymium, cerium, samarium, and combinations thereof.

24. The catalyst according to claim 1 wherein the rare earth-rich aluminate comprises lanthanum.

25. The catalyst according to claim 1 wherein the rare earth metal in the catalyst is applied by a surface deposition of a solution of a rare earth metal precursor onto discrete structures of an aluminum-containing precursor material selected from the group consisting of one or more transition aluminas, boehmite, pseudo-boehmite, and combinations thereof, and then calcined at a temperature sufficient to convert the aluminum atoms from the aluminum-containing precursor material to at least two rare-earth aluminates of different aluminum to rare earth metal molar ratios.

26. The catalyst according to claim 1 wherein the rare earth-rich aluminate is predominantly located in an outer layer covering an inner core comprising the rare earth-lean aluminate.

27. The catalyst according to claim 1 wherein the discrete structures of the support comprise: an outer layer comprising the rare earth-rich aluminate with a molar ratio of aluminum to rare earth metal between 1:2 and 2:1, and
an inner core comprising the rare earth-lean aluminate with a molar ratio of aluminum to rare earth metal greater than 5:1,
wherein the outer layer is essentially free of an alumina phase.

28. The catalyst according to claim 27 wherein the outer layer covers completely the inner core.

29. The catalyst according to claim 27 wherein the outer layer comprises the outer 10% of the catalyst particle as measured from the outer surface of the discrete structures and radiating inward to the center of the discrete structures.

30. The catalyst according to claim 27 wherein the outer layer comprises the outer 6% of the catalyst particle as measured from the outer surface of the particulate catalyst and radiating inward to the center of the particulate catalyst.

31. The catalyst according to claim 27 wherein the outer layer comprises the outer 4% of the catalyst particle as measured from the outer surface of the particulate catalyst and radiating inward to the center of the particulate catalyst.

32. The catalyst according to claim 27 wherein the inner core further comprises alpha-alumina.

33. The catalyst according to claim 27 wherein the active ingredient is located within the outer layer and the inner core.

34. The catalyst according to claim 1 wherein the catalyst exhibits a daily deactivation rate in hydrocarbon conversion of 1% or less for the first 10 days of use under conditions suitable for catalytic partial oxidation of one or more light hydrocarbons at a super atmospheric pressure greater than 200 kPa.

35. The catalyst according to claim 1 wherein the catalyst exhibits a daily deactivation rate in CO selectivity or in hydrogen selectivity of 1% or less for the first 10 days of use under conditions suitable for catalytic partial oxidation of one or more light hydrocarbons.

36. A method for making synthesis gas comprising:
converting a gaseous hydrocarbon stream and an oxygen-containing stream over a partial oxidation catalyst, to make a product stream comprising CO and H₂,
wherein said partial oxidation catalyst includes
an active ingredient comprising a metal selected from the group consisting of rhodium, iridium, platinum, palladium, ruthenium, and combinations thereof; and
a support in the form of discrete structures, said support comprising a rare earth-lean aluminate having a molar ratio of aluminum to rare-earth metal greater than 5:1, and a rare earth-rich aluminate having a molar ratio of aluminum to rare-earth metal greater than 5:1.

37. The method according to claim 36 wherein both rare earth aluminates comprise the same rare earth metal selected from the group consisting of lanthanum, neodymium, praseodymium, cerium, samarium, and combinations thereof.

38. The method according to claim 36 wherein both rare earth aluminates comprise lanthanum.

39. The method according to claim 38 wherein the catalyst comprises between 19.2 wt % and 65 wt % of lanthanum based on the total weight of the catalyst, exclusive of endpoints.

40. The method according to claim 38 wherein the catalyst comprises between 20 wt % and 30 wt % of lanthanum based on the total weight of the catalyst, inclusive of endpoints.

41. The method according to claim 36 wherein the rare earth-rich aluminate comprises a perovskite structure.

42. The method according to claim 36 wherein the rare earth-lean aluminate comprises a hexaaluminate structure.

43. The method according to claim 36 wherein the catalyst further contains less than 25 wt % alpha-alumina.

44. The method according to claim 36 wherein the rare earth-rich aluminate is predominantly located in an outer layer covering an inner core comprising the rare earth-lean aluminate.

45. The method according to claim 44 wherein the active ingredient is located within the outer layer and the inner core.

46. The method according to claim 36 wherein the gaseous hydrocarbon stream comprises methane.

47. The method according to claim 46 wherein the gaseous hydrocarbon stream is at a super atmospheric pressure of about 700 kPa or greater, and further wherein the catalyst exhibits a CO selectivity of about 85% or greater, a hydrogen selectivity of about 85% or greater and a methane conversion of about 85% or greater after 10 days on line under conditions suitable for catalytic partial oxidation of one or more light hydrocarbons.

48. The method according to claim 46 wherein the catalyst exhibits a carbon dioxide selectivity of about 5% or less.

49. The method according to claim 46 wherein the catalyst exhibits a C₂₊ selectivity of about 1% or less.

50. The method according to claim 36 wherein the catalyst exhibits less than about a 1% daily deactivation rate in hydrocarbon conversion, or in CO selectivity, or in hydrogen selectivity over the first 10 days of use under conditions suitable for catalytic partial oxidation of said hydrocarbon.

51. The catalyst according to claim 36 wherein the catalyst exhibits less than about a 0.5% daily deactivation rate in hydrocarbon conversion or in CO selectivity, or in hydrogen selectivity, over the first 10 days of use under conditions suitable for catalytic partial oxidation of said hydrocarbon.

52. The method of claim 36 wherein at least a portion of the product stream comprising CO and H₂ is further converted to synthesized hydrocarbons, wherein said synthesized hydrocarbons comprise at least in part components of transportation fuels.

53. A method for making a thermally stable supported syngas catalyst suitable for long-term operation in a partial oxidation reactor at high pressure and temperature, said method comprising the following steps:
impregnating a solution of a rare earth metal-containing compound onto an aluminum-containing precursor in the form of discrete structures;
drying the impregnated aluminum-containing precursor;
calcining at a temperature of about 1,100° C. or higher in a manner effective so as to react the aluminum-containing precursor with at least a fraction of said rare earth metal to form a support comprising a rare earth-rich aluminate, a rare earth-lean aluminate, and less than 25 wt % of alumina, wherein the rare earth-rich aluminate has a molar ratio of aluminum to rare earth metal less than 5:1, and the rare earth-lean aluminate has a molar ratio of aluminum to rare earth metal greater than 5:1;
depositing an active ingredient compound onto said support, wherein the active ingredient comprises a metal selected from the group consisting of rhodium, iridium, platinum, palladium, ruthenium, oxides thereof, and combinations thereof,
calcining and reducing the deposited support so as to form an activated catalyst, and heat treating the activated catalyst in an inert atmosphere at a temperature of at least about 1,100° C. to obtain the thermally stable supported syngas catalyst.

54. The method of claim 53 further comprising heat treating the activated catalyst in an inert atmosphere at a temperature of from about 1250° C. to about 1600° C.

55. The method of claim 53 wherein the aluminum-containing precursor comprises a transition alumina selected from the group consisting of gamma-alumina, delta-alumina, chi-alumina, rho-alumina, kappa-alumina, eta-alumina, theta-alumina, and combinations thereof.

56. The method of claim 53 wherein the aluminum-containing precursor comprises mostly gamma-alumina.

57. The method of claim 53 wherein calcining is done at a temperature between 1,100° C. and 1,600° C.

58. The method of claim 53 wherein calcining is done at a temperature between 1,300° C. and 1,500° C.

59. The method of claim 53 wherein the rare earth metal is selected from the group consisting of lanthanum, neodymium, praseodymium, samarium, cerium and combinations thereof.

60. The method of claim 53 wherein both rare earth aluminates comprises lanthanum.

61. The method of claim 53 wherein the solution of rare earth metal comprises more than one rare-earth metal.

62. The method of claim 53 wherein the rare earth-lean aluminate comprises a hexaaluminate structure, a beta-aluminate structure, or combinations thereof.

63. The method of claim 53 wherein the rare earth-rich aluminate comprises a perovskite structure.

64. The method of claim 53 wherein the rare earth-lean aluminate comprises a lanthanum hexaaluminate, and wherein the rare earth-rich aluminate comprises a lanthanum aluminate perovskite.

65. The method of claim 53 wherein the support comprises a rare earth content greater than the stoichiometric rare earth content of the corresponding rare earth hexaaluminate structure but lower than the stoichiometric rare earth content of the corresponding rare earth aluminate perovskite, exclusive of said stoichiometric rare earth contents.

66. The method of claim 53 wherein the catalyst further comprises less than 15 wt % alumina.
